(19) United States
(12) Patent Application Publication
(10) Pub. No.: US 2016/0262169 A1
(43) Pub. Date: Sep. 8, 2016

(54) WLAN COMMUNICATION SCHEDULING ON A SHARED WLAN TRANSCEIVER CHAIN

(71) Applicant: QUALCOMM Incorporated, San Diego, CA (US)

(72) Inventors: Soumya Das, San Diego, CA (US); Olufunmilola Awoniyi-Oteri, San Diego, CA (US)

(21) Appl. No.: 14/640,414

(22) Filed: Mar. 6, 2015

(51) Int. Cl. H04W 72/12; H04J 3/16; H04W 52/02; H04W 74/04

(52) U.S. Cl. CPC H04W 72/1215; H04W 74/04; H04J 3/1694; H04W 52/0206; H04W 84/12

(57) ABSTRACT

A user equipment (UE) may include a wireless local area network (WLAN) transceiver chain that is used for both WLAN communications and communications on another wireless radio access technology (RAT), such as wireless wide area network (WWAN) communications. The communications may be synchronized, and then at least a portion of the WLAN transceiver chain may be scheduled for time-division multiplexed (TDM) communications, wherein a first set of TDM intervals are for communications using the other RAT, and a second set of TDM intervals are for communications using the WLAN.

### BACKGROUND

1. Field of the Disclosure

The present disclosure, for example, relates to wireless communication systems, and more particularly to use of a shared wireless local area network (WLAN) transceiver chain for time-division multiplexed (TDM) communications using first and second communication protocols.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple wireless devices. Base stations may communicate with wireless devices on downstream and upstream links. Each base station has a coverage range, which may be referred to as the coverage area of the cell. The wireless devices that communicate with a base station may be referred to as user equipments (UEs).

In addition to communicating with a base station, a UE may also communicate with an access point (AP). UEs that communicate with an AP may also be referred to as wireless stations (STAs). Communication with a base station and an access point may use different radio access technologies (RATs). For example, communication between a UE and a base station may use a wireless wide area network (WWAN), while communication between a UE and an access point may use a wireless local area network (WLAN). One example WLAN communication protocol is Bluetooth communication.

A UE may include multiple radios. For example, a UE may include both a WWAN radio and a WLAN radio which may each include separate antennas, modems or other components. However, there may be times that at least portions of a single radio may be used for both WWAN and WLAN communications. As an example, a UE may, at times, use a WLAN radio to facilitate both WLAN communications and certain types of WWAN communications. Coordination between the WWAN communications and the WLAN communications on the WLAN radio may be useful in order to reduce potential interference.

### SUMMARY

A user equipment (UE) may include multiple radios that may generally be used for different radio access technologies (RATs). However, a UE may also use at least portions of the same radio for different RATs. In the case where a UE uses portions of a single radio for both wireless local area network (WLAN) and wireless wide area network (WWAN) communications, the UE may include functionality to synchronize and schedule the WLAN and WWAN communications. In particular, when the UE is engaged in time-division multiplexed (TDM) WWAN communications such as Global System for Mobile (GSM) transmit (Tx) and receive (Rx) operations on portions of a WLAN transceiver chain, the TDM WLAN communications on the same WLAN transceiver chain may be synchronized and scheduled to occur on TDM intervals that are different from the TDM intervals used by the WWAN communications. In order to facilitate the scheduling, the UE may transmit a trigger frame or other timing information, for example, to an access point (AP) transmitting the WLAN communications received by the UE. Scheduling and synchronization may also occur when the UE is participating in peer-to-peer (P2P) WLAN communications.

In a first set of illustrative examples, a method for wireless communications is described. In one configuration, the method may include synchronizing WLAN communications using a first RAT with a second RAT timeline. The method may also include scheduling at least a portion of a WLAN transceiver chain for TDM communications, wherein a first set of TDM intervals are for communications using a second RAT having the second RAT timeline, and a second set of TDM intervals are for communications using the first RAT. The WLAN transceiver chain may be used according to the schedule.

In some embodiments of the method, the scheduling of at least the portion of the WLAN transceiver chain may include scheduling the WLAN communications to occur on the second set of TDM intervals so as to avoid overlap with the first set of TDM intervals. The scheduling of at least the portion of the WLAN transceiver chain may also include scheduling the WLAN communications to occur during the second set of TDM intervals and in between the first set of TDM intervals which include subsequent GSM Tx operations, subsequent GSM Rx and power management (PM) operations, or subsequent combined GSM Tx/Rx operations. The scheduling of at least the portion of the WLAN transceiver chain may include scheduling the communications using the second RAT to occur in accordance with a power save mechanism of the first RAT. Using the WLAN transceiver chain may include transmitting a trigger frame to an AP to trigger a transmission of one or more downlink packets buffered at the AP during the second set of TDM intervals.

Using the WLAN transceiver chain may also include transmitting to an access point (AP) timing information of the second RAT. The method may additionally include receiving the WLAN communications from the AP, wherein at least one of the rate, modulation and coding scheme (MCS), power level, or degree of aggregation of the WLAN communications is determined by the AP based at least in part on the timing information of the second RAT. The method may also include receiving the WLAN communications from the AP during a contention free period established by the AP based at least in part on the timing information of the second RAT. The contention free period may be aligned with a start of the second set of TDM intervals. The contention free period may be one of a plurality of contention free periods established by the AP, each of the plurality of contention free periods corresponding to different devices having corresponding different WLAN transceiver chains. The WLAN communications may be received from the AP during the contention free period without a transmission of a trigger frame to the AP. Further, the method may include receiving the WLAN communications from devices other than the AP during a second portion of a contention free period established by the AP based at least in part on the timing information of the second RAT, wherein the receiving of the WLAN communications during the second portion of the contention free period is based in part on a lack of receipt of WLAN communications from the AP during a first portion of the contention free period and is based in part on the devices other than the AP winning a contention during the second portion of the contention free period.

In some embodiments, the using of the WLAN transceiver chain may include transmitting a trigger frame to an AP to trigger a transmission of downlink packets buffered at the AP during the second set of TDM intervals, determining a time required for the transmission of downlink packets from the AP, and determining a guard interval, based at least in part on the time required for the transmission of downlink packets, during which no additional trigger frames are transmitted. In certain embodiments, the using of the WLAN transceiver chain may include transmitting a trigger frame to an AP to trigger a transmission of downlink packets buffered at the AP during the second set of TDM intervals, and including in the trigger frame a duration of the second set of TDM intervals during which the WLAN communications are scheduled. The method may further include receiving the WLAN communications from the AP, wherein at least one of the rate, MCS, power level, or degree of aggregation of the WLAN communications is determined by the AP based at least in part on the duration of the second set of TDM intervals during which the WLAN communications are scheduled.

In some embodiments of the method, using the WLAN transceiver chain may include using the WLAN transceiver chain as a group owner (GO) for P2P WLAN communications. In these embodiments, the method may further include aligning a P2P beacon interval with a frame of the second RAT timeline, suspending the communications using the second RAT during a limited presence period at a beginning of the P2P beacon interval, and re-starting the communications using the second RAT after the limited presence period. The method may also further include aligning a GO absence pattern with a frame of the second RAT such that the communications using the second RAT occur during GO absence time periods. The method may also further include determining, by the GO, at least one of a rate, MCS, power level, or degree of aggregation of the WLAN communications based at least in part on timing information of the second RAT.

In some embodiments of the method, using the WLAN transceiver chain may include using the WLAN transceiver chain as a client for P2P WLAN communications. In these embodiments, the method may further include transmitting a request to a P2P WLAN GO that the GO be available for a time duration and time corresponding to the second set of TDM intervals that are at least partially in between the first set of TDM intervals, and participating in at least a portion of the P2P WLAN communications at the requested time and time duration.

In a second set of illustrative examples, an apparatus for wireless communication is described. In one configuration, the apparatus may include means for synchronizing WLAN communications using a first RAT with a second RAT timeline, means for scheduling at least a portion of a WLAN transceiver chain for TDM communications, wherein a first set of TDM intervals are for communications using a second RAT having the second RAT timeline, and a second set of TDM intervals are for communications using the first RAT, and means for using the WLAN transceiver chain according to the schedule. In some examples, the apparatus may further include means for implementing one or more aspects of the method for wireless communication described above with respect to the first set of illustrative examples.

In a third set of illustrative examples, another apparatus for wireless communication is described. In one configuration, the apparatus may include a processor, memory in electronic communication with the processor, and instructions stored in the memory. The instructions may be executable by the processor to synchronize WLAN communications using a first RAT with a second RAT timeline. The instructions may also be executable by the processor to schedule at least a portion of a WLAN transceiver chain for TDM communications, wherein a first set of TDM intervals are for communications using a second RAT having the second RAT timeline, and a second set of TDM intervals are for communications using the first RAT. The instructions may also be executable by the processor to use the WLAN transceiver chain according to the schedule. In some examples, the instructions may also be executable by the processor to implement one or more aspects of the method for wireless communication described above with respect to the first set of illustrative examples.

In a fourth set of illustrative examples, a non-transitory computer-readable medium storing computer-executable code for wireless communication is described. In one configuration, the code may be executable by a processor to synchronize WLAN communications using a first RAT with a second RAT timeline. The code may be executable by the processor to schedule at least a portion of a WLAN transceiver chain for TDM communications, wherein a first set of TDM intervals are for communications using a second RAT having the second RAT timeline, and a second set of TDM intervals are for communications using the first RAT. The code may also be executable by the processor to use the WLAN transceiver chain according to the schedule. In some examples, the code may also be used to implement one or more aspects of the method for wireless communication described above with respect to the first set of illustrative examples.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a system diagram of a wireless communication system, in accordance with various aspects of the present disclosure;

FIG. 2 shows a system diagram of a wireless communication system, in accordance with various aspects of the present disclosure;

FIG. 3 shows a timeline for wireless local area network (WLAN) scheduling on a shared WLAN transceiver chain, in accordance with various aspects of the present disclosure;

FIG. 4 shows a timeline for WLAN scheduling on a shared WLAN transceiver chain, in accordance with various aspects of the present disclosure;

FIG. 5 shows a timeline for WLAN scheduling on a shared WLAN transceiver chain, in accordance with various aspects of the present disclosure;

FIG. 6 shows a timeline for peer-to-peer (P2P) WLAN scheduling on a shared WLAN transceiver chain, in accordance with various aspects of the present disclosure;

FIG. 7 shows a timeline for P2P WLAN scheduling on a shared WLAN transceiver chain, in accordance with various aspects of the present disclosure;

FIG. 8 shows a timeline for P2P WLAN scheduling on a shared WLAN transceiver chain, in accordance with various aspects of the present disclosure;

FIG. 9 shows a block diagram of an apparatus configured for use in wireless communication, in accordance with various aspects of the present disclosure;

FIG. 10 shows a block diagram of an apparatus configured for use in wireless communication, in accordance with various aspects of the present disclosure;

FIG. 11 shows a block diagram of a wireless communication system, in accordance with various aspects of the present disclosure;

FIG. 12 shows a block diagram of a device configured for use in wireless communication, in accordance with various aspects of the present disclosure;

FIG. 13 shows a block diagram of a wireless communications system, in accordance with various aspects of the present disclosure; and

FIGS. 14-19 are flow charts illustrating examples of methods for wireless communication, in accordance with various aspects of the present disclosure.

### DETAILED DESCRIPTION

Many user equipments (UEs) include multiple radios so as to facilitate communications on different radio access technologies (RATs). In one example, a UE may include one or more wireless wide area network (WWAN) radios and may also include at least one wireless local area network (WLAN) radio. The radios may include antennas and corresponding modems, and may each include receive (Rx) and transmit (Tx) chains, otherwise known as transceiver chains. While a UE may typically use its WLAN radio for WLAN communications, the UE may have need to also use its WLAN radio for various WWAN communications. For example, when all of a UE's WWAN radios are being used and the UE has need of additional WWAN capabilities, the UE's WLAN transceiver chain may be used to facilitate the additional WWAN operations. One example scenario where a UE may use its WLAN transceiver chain for WWAN operations is when a UE is using all of its WWAN radios for ongoing WWAN communications and has need to conduct additional inter frequency WWAN cell search and measurement operations. In this example, the UE may use its WLAN transceiver chain to perform the additional inter-frequency WWAN cell search and measurement operations. Another example scenario where a UE may use its WLAN transceiver chain for WWAN operations is when a UE includes multiple subscriber identity modules (SIMs) and supports, for example, dual SIM dual active (DSDA) operations. If all of the UE's WWAN radios are being used in association with a first SIM, the UE's WLAN transceiver chain may be used in association with WWAN operations associated with a second SIM. In using the WLAN transceiver chain to support these additional WWAN operations, the UE may avoid or reduce interruption to its ongoing WWAN communications.

However, use of the UE's WLAN transceiver chain for WWAN operations may benefit from coordination of the WWAN and WLAN communications carried out on the shared WLAN transceiver chain. One form of coordination may be performed with respect to time-division multiplexed (TDM) communications. An example of a TDM WWAN communication protocol is Global System for Mobile (GSM) communication. A TDM WWAN communication protocol may involve operations on specific TDM intervals or slots. Thus, if these TDM intervals are known, WLAN communications on the same radio may be synchronized and scheduled to occur on TDM intervals that are different from those used by the WWAN communications. Scheduling of different TDM intervals for WWAN and WLAN communications on a shared WLAN transceiver chain may be especially helpful when the communication protocols being used have synchronous timing requirements, such as in the case of GSM and Bluetooth communications.

For example, synchronization and scheduling using TDM intervals may be used for sharing a WLAN transceiver chain using 2.4 GHz or 5 GHz WLAN communications and GSM (900 Hz or 1800 MHz) communications. Synchronization and scheduling using TDM intervals may also be used for sharing a WLAN transceiver chain using 2.4 GHz WLAN communications and Bluetooth, though, in this scenario, other non-TDM options may also be considered for coordinating use of the shared WLAN transceiver chain.

Therefore, and as described in detail below, when a WLAN transceiver chain is used for both WWAN communications and WLAN communications, the WLAN communications may be synchronized to the WWAN communications. The WLAN transceiver chain may then be scheduled for TDM communications, where a first set of TDM intervals may be used for the WLAN communications and a second set of TDM intervals may be used for the WWAN communications. In one example, the WWAN communications may be GSM communications. In another example, the WLAN communications may be peer-to-peer (P2P) WLAN communications.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

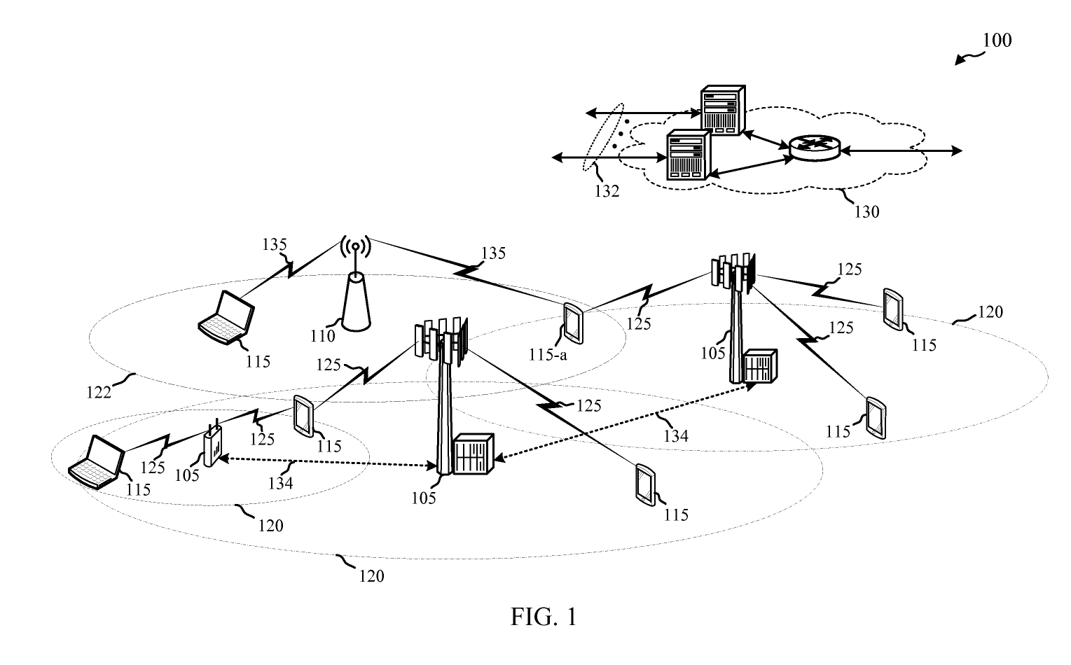

Referring first to FIG. 1, a system diagram illustrates an example of a wireless communication system 100. The wireless communication system 100 may include base station(s) 105, access point(s) (AP) 110, and mobile devices such as UEs 115. The AP 110 may provide wireless communications via a WLAN radio access network (RAN) such as, e.g., a network implementing at least one of the IEEE 802.11 family of standards. The AP 110 may provide, for example, Bluetooth communications access to a UE. Each AP 110 has a geographic coverage area 122 such that UEs 115 within that area can typically communicate with the AP 110. UEs 115 may be multi-access mobile devices that communicate with the AP 110 and a base station 105 via different radio access networks. UEs 115 that communicate with an AP 110 are sometimes referred to as wireless stations (STAs). UEs 115 that communicate with a base station 105 are generally referred to as UEs. In the discussion below relating to UEs 115-a that communicate with both APs 110 and base stations 105, the UE 115-a will be referred to as a UE. UEs 115, such as mobile stations, personal digital assistants (PDAs), other handheld devices, netbooks, notebook computers, tablet computers, laptops, display devices (e.g., TVs, computer monitors, etc.), printers, etc., may be stationary or mobile and traverse the geographic coverage areas 122 and/or 120, the geographic coverage area of a base station 105. While only one AP 110 is illustrated, the wireless communication system 100 may include multiple APs 110. Some or all of the UEs 115 may associate and communicate with an AP 110 via a communication link 135 and/or with a base station 105 via a communication link 125.

The wireless communications system 100 may also include a core network 130. The core network 130 may provide user authentication, access authorization, tracking, Internet Protocol (IP) connectivity, and other access, routing, or mobility functions. The base stations 105 interface with the core network 130 through backhaul links 132 (e.g., 51, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

Although not shown in FIG. 1, a UE 115 can be covered by more than one AP 110 and/or base station 105 and can therefore associate with multiple APs 110 or base stations 105 at different times. For example, a single AP 110 and an associated set of UEs 115 may be referred to as a basic service set (BSS). An extended service set (ESS) is a set of connected BSSs. A distribution system (DS) (not shown) is used to connect APs 110 in an extended service set. A geographic coverage area 122 for an access point 110 may be divided into sectors making up only a portion of the geographic coverage area (not shown). The wireless communication system 100 may include APs 110 of different types (e.g., metropolitan area, home network, etc.), with varying sizes of coverage areas and overlapping coverage areas for different technologies. Although not shown, other wireless devices can communicate with the AP 110.

The base stations 105 may wirelessly communicate with the UEs 115 via base station antennas. Each of the base station 105 sites may provide communication coverage for a respective geographic coverage area 120. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 120 for a base station 105 may be divided into sectors making up only a portion of the coverage area (not shown). The wireless communication system 100 may include base stations 105 of different types (e.g., macro and/or small cell base stations). There may be overlapping geographic coverage areas 120/122 for different technologies.

In some examples, the wireless communication system 100 includes portions of a Long Term Evolution (LTE)/LTE-Advanced (LTE-A) network. In LTE/LTE-A networks, the term evolved Node B (eNB) may be generally used to describe the base stations 105, while the term UE may be generally used to describe the UEs 115. The wireless communication system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

In other examples, the wireless communication system 100 may include portions of a GSM network. In GSM networks, the term base station may be generally used to describe the base stations 105, while the term UE or wireless device may be generally used to describe the UEs 115.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for synchronous or near-synchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network supporting radio bearers for the user plane data. At the Physical (PHY) layer, the transport channels may be mapped to Physical channels.

The UEs 115 are dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, APs, and the like.

The communication links 125 shown in wireless communication system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the system 100, base stations 105, APs 110, and/or UEs 115 may include multiple antennas for employing antenna diversity schemes to improve communication quality and reliability between base stations 105, APs 110, and UEs 115. Additionally or alternatively, base stations 105, APs 110, and/or UEs 115 may employ multiple-input, multiple-output (MIMO) techniques that may take advantage of multi-path environments to transmit multiple spatial layers carrying the same or different coded data.

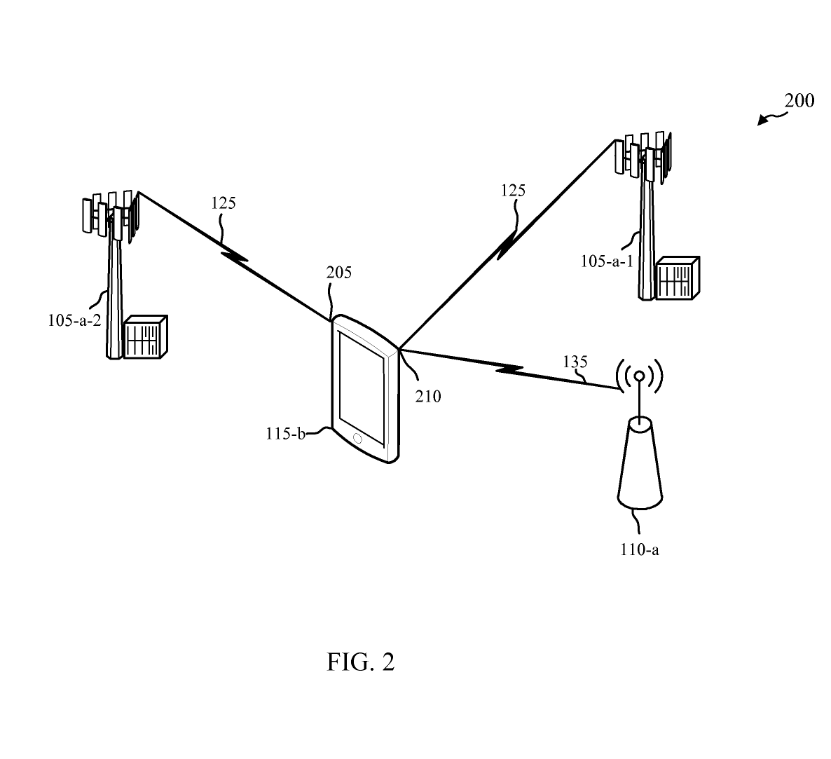

System 100 includes a UE 115-a which is in communication with both a base station 105 and an access point 110. As an example, UE 115-a may communicate with the access point 110 using WLAN communications while the UE 115-a may communicate with the base station 105 using GSM or other WWAN communications. The communications may be at the same time. As an example, the UE 115-a may be used for WLAN communications at a same time that the UE 115-a is used for cellular communications such as GSM communications. Additionally, while the simultaneous WLAN and WWAN communications are occurring, the UE 115-a may have further need to conduct an inter-frequency WWAN cell search and measurement or to engage a second SIM supporting additional WWAN operations such as GSM operations. This situation is illustrated in greater detail in FIG. 2.

FIG. 2 illustrates a system diagram that shows an example of a wireless communication system 200. The wireless communication system 200 may include base stations 105-a-1, 105-a-2, AP 110-a and UE 115-b. The UE 115-b may be an example of UE 115-a in system 100 of FIG. 1 and may be engaged in both WWAN and WLAN communications. The base stations 105-a-1, 105-a-2 may be examples of base stations 105 included in system 100 of FIG. 1, and the AP 110-a may be an example of the AP 110 in system 100 of FIG. 1.

In system 200, the UE 115-b may include at least two different radios 205, 210. For example, radio 205 may be a WWAN radio and may be associated with a WWAN modem. Using the radio 205, the UE 115-b may engage in WWAN communications with base station 105-a-2 via communication link 125. The radio 205 and associated WWAN modem may include both Rx and Tx chains (i.e., transceiver chains) used during WWAN communications.

The UE 115-b may also include radio 210 which may be a WLAN radio. In system 200, the UE 115-b uses the radio 210 to communicate with both the base station 105-a-1 (via communication link 125) and the AP 110-a (via communication link 135). The communications with the AP 110-a may include WLAN communications, while the communication with the base station 105-a-1 may be part of a WWAN cell search and measurement operation or DSDA operation, for example. Thus, both the WWAN communications and the WLAN communications may share a Rx chain, a Tx chain, or both of a WLAN modem associated with the radio 210. The sharing of the radio 210 may benefit from some coordination between the WWAN operations and the WLAN communications, as explained in further detail below.

Coordination between the WWAN operations and the WLAN communications may involve both synchronization and scheduling of TDM intervals used by the different communication protocols. For example, in FIG. 2, the communications between the UE 115-b and the base station 105-a-1 may include TDM communications, such as GSM communications. Additionally, the communications between the UE 115-b and the AP 110-a may include TDM WLAN communications. Therefore, the different TDM communications may be synchronized and scheduled such that the GSM communications occur on TDM intervals that are different from those used for the WLAN communications. In an example, the WLAN communications are synchronized to the GSM communications. However, in other examples, the GSM or other WWAN communications may be synchronized to the WLAN communications.

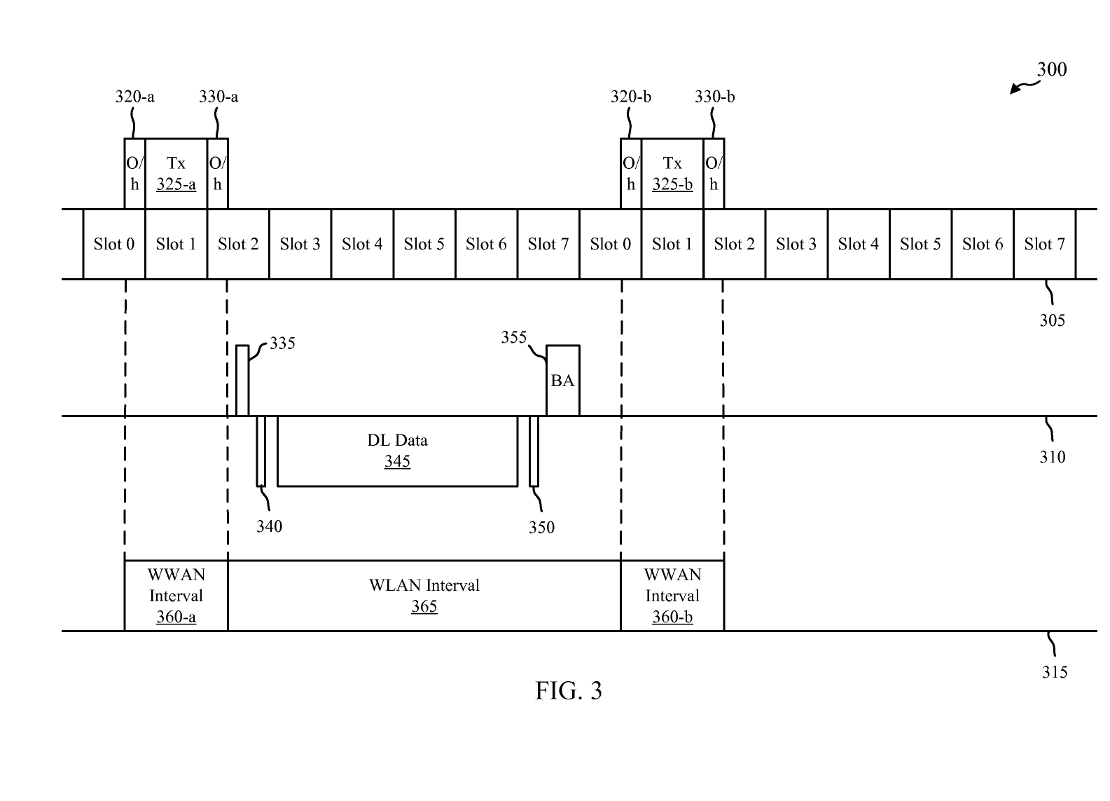

FIG. 3 illustrates a timeline 300 for WLAN scheduling on a shared WLAN transceiver chain of a radio such as radio 210 of UE 115-b of FIG. 2. In particular, timeline 300 illustrates the synchronization of WLAN TDM operations with GSM operations, and the scheduling of TDM intervals for both the WLAN and the GSM communications. In timeline 300, the GSM communications only include GSM Tx communications. Timeline 300 includes three component timelines: a GSM timeline 305, a WLAN timeline 310, and a UE timeline 315.

The GSM communications are illustrated on the GSM timeline 305. The GSM timeline 305 illustrates periodic GSM frames. The GSM frames are divided into time slots. In the example of FIG. 3, the GSM timeline 305 includes eight slots within each GSM frame, labeled as slots 0-7. In an example, the slots may each be approximately 577 μs in duration, while the GSM frame is approximately 4.616 ms. Within each GSM frame are GSM communications. The GSM communications illustrated in GSM timeline 305 are also periodic and involve at least portions of slots 0, 1 and 2 within each period. The GSM communications include at least a Tx portion 325 flanked in time by two radio frequency (RF) switching overhead portions 320, 330. Thus, in FIG. 3, RF switching overhead portion 320-a begins during slot 0 and is followed by the Tx portion 325-a which occupies slot 1. After the Tx portion 325-a is complete, RF switching overhead portion 330-a begins, occupying a portion of slot 2. The GSM communications occur again eight slots later in the form of RF switching overhead portion 320-b, Tx portion 325-b, and RF switching overhead portion 330-b. The RF switching overhead portions 320, 330 allow sufficient time for the WLAN radio to shift between GSM operations (such as the Tx portions 325) and WLAN operations, illustrated on the WLAN timeline 310.

The WLAN communications are illustrated on the WLAN timeline 310. The WLAN communications are synchronized with the GSM communications on the GSM timeline 305, and are scheduled so that there is no overlap between the WLAN communications and the GSM communications. The WLAN communications may include both WLAN communications from a UE 115 (such as UE 115-b of FIG. 2) and WLAN communications received at the UE 115 from an AP (such as from AP 110-a of FIG. 2). The communications transmitted from the UE 115 to the AP 110 are illustrated above the horizontal line of the WLAN timeline 310, while the communications received at the UE 115 from the AP 110 are illustrated below the horizontal line of the WLAN timeline 310.

The WLAN communications may include an initial transmission of a trigger frame 335 from the UE 115 to the AP 110. The trigger frame 335 may be sent to poll the AP 110 for any DL packets that are to be sent from the AP 110 to the UE 115. As an example, the trigger frame 335 may be a power save (PS)-POLL frame. In response to the trigger frame 335, the AP 110 may transmit an acknowledgment (ACK) 340, followed by a transmission of DL data 345. The DL data 345 may be in the form of an aggregated MAC protocol data unit (A-MPDU), for example. The transmission of the DL data 345 may be followed by a transmission of a block acknowledgment request (BAR) 350 to the UE 115. The UE 115 may respond with a block acknowledgment (BA) 355.

The entirety of the WLAN communication are synchronized and scheduled to occur on portions of slots 2-7 of the GSM frame. Importantly, in this example, the WLAN communications occur during TDM intervals not used for GSM communications.

Thus, UE timeline 315 illustrates distinct WWAN intervals 360 and WLAN intervals 365 during which the WLAN transceiver chain of the UE 115 may be used for corresponding WWAN communications and WLAN communications. WWAN interval 360-a corresponds to the WWAN communications utilizing the RF switching overhead portions 320-a, 330-a and Tx portion 325-a, WLAN interval 365 corresponds to the WLAN communications that include the trigger frame 335, the ACK 340, the DL data 345, the BAR 350, and the BA 355, and WWAN interval 360-b corresponds to the WWAN communications utilizing the RF switching overhead portions 320-b, 330-b and Tx portion 325-b.

While the WLAN timeline 310 of FIG. 3 illustrates that the DL data 345 transmitted in response to the trigger frame 335 may essentially occupy the entirety of the WLAN interval 365, there may be instances where the DL data 345 occupies significantly less time. In such circumstances, the UE 115 may send one or more additional trigger frames 335 to trigger download of additional DL data packets. However, to ensure that there is sufficient time within the WLAN interval 365 for receipt of each DL data 345, the UE 115 may measure the time needed for each WLAN communication (for example, from each trigger frame 335 to BA 355) and then use these measurements to determine and enforce a guard interval during which no additional trigger frames 335 may be attempted.

The timeline 300 illustrates an example timing for GSM and WLAN operations on a shared WLAN transceiver chain when the GSM communications are limited to Tx operations. In this scenario, the GSM frame is approximately 4.62 ms, and of that time, approximately 1 ms is not available for WLAN communications. This is a significantly better ratio than that typically allowed between WLAN communications and Bluetooth extended synchronous connection oriented (eSCO) communications (for example, for voice-based communications), which may also often share a same WLAN transceiver chain. For example, an eSCO frame may be approximately 3.75 ms, during which the other WLAN communications may suffer an outage (during which the WLAN transceiver chain is being used for the eSCO communications) of approximately 1.25 ms (without any retransmission of the eSCO communications). However, the time available for WLAN communications on a shared WLAN radio decreases as additional GSM operations are used on the shared WLAN radio.

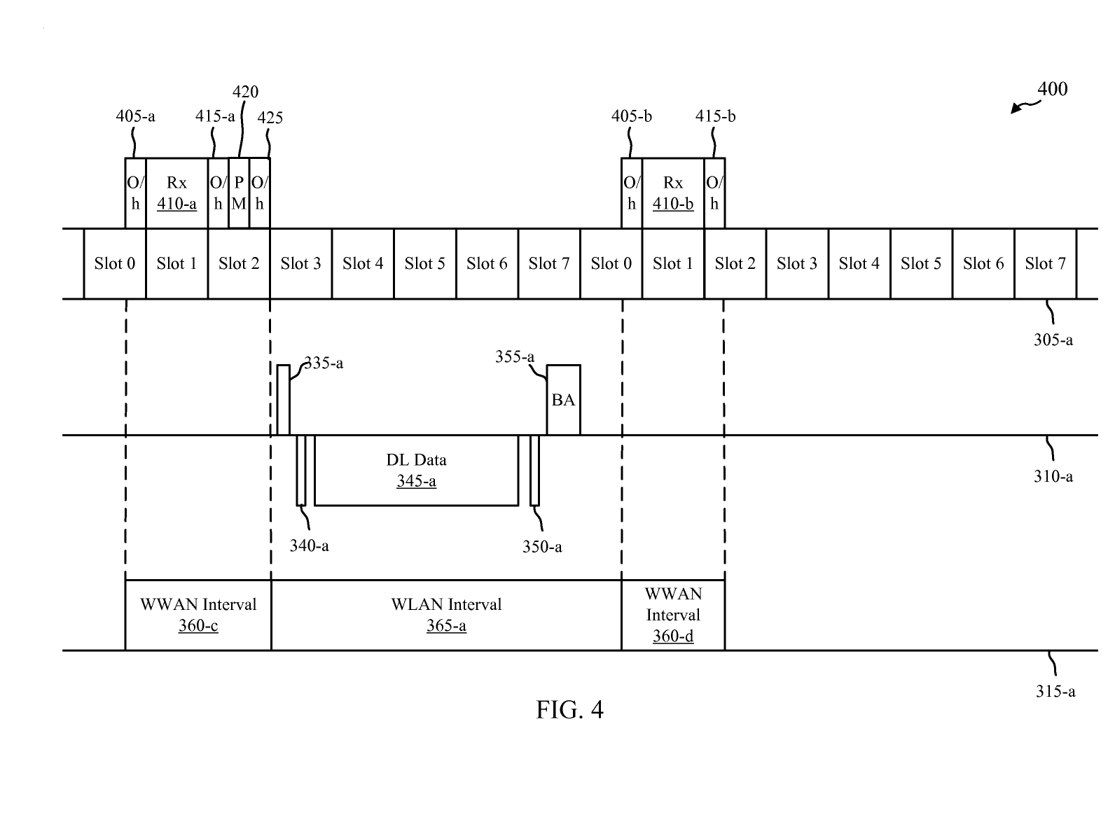

FIG. 4 illustrates a timeline 400 for WLAN scheduling on a shared WLAN transceiver chain of a radio such as radio 210 of UE 115-b of FIG. 2. In particular, timeline 400 illustrates the synchronization of WLAN TDM operations with GSM operations, and the scheduling of TDM intervals for both the WLAN and the GSM communications. In timeline 400, the GSM communications only include GSM Rx communications. Timeline 400 includes three component timelines: a GSM timeline 305-a, a WLAN timeline 310-a, and a UE timeline 315-a.

The GSM communications are illustrated on the GSM timeline 305-a. Like GSM timeline 305 of FIG. 3, the GSM timeline 305-a illustrates periodic GSM frames divided into slots (slots 0-7 in each frame). Within each GSM frame are GSM communications. The GSM communications illustrated in GSM timeline 305-a are periodic and involve at least portions of slots 0, 1 and 2 within each period. The GSM communications include at least an Rx portion 410 flanked in time by RF switching overhead portions 405, 415, and 425, and power management (PM) portion 420. Thus, in FIG. 4, RF switching overhead portion 405-a begins during slot 0 and is followed by the Rx portion 410-a which occupies slot 1. After the Rx portion 410-a is complete, RF switching overhead portion 415-a begins, occupying a portion of slot 2. The RF switching overhead portion 415-a is followed by a PM portion 420 and another RF switching overhead portion 425. The PM portion 420 is used in order to allow for switching of the WLAN transceiver chain between the GSM Rx frequency and the WLAN frequencies. The GSM communications occur again eight slots later in the form of RF switching overhead portion 405-b, Rx portion 410-b, and RF switching overhead portion 415-b. As no additional WLAN operations occur after the RF switching overhead portion 415-b, no additional PM portions 420 are indicated in the GSM timeline 305-a. However, if additional WLAN communications were to occur, additional PM portions 420 would also be used.

The WLAN communications are illustrated on the WLAN timeline 310-a. The WLAN communications are synchronized with the GSM communications on the GSM timeline 305-a, and are scheduled so that there is no overlap between the WLAN communications and the GSM communications. The WLAN communications may include both WLAN communications from a UE 115 (such as UE 115-b of FIG. 2) and WLAN communications received at the UE 115 from an AP (such as from AP 110-a of FIG. 2). The WLAN communications illustrated on timeline 310-a are the same as those illustrated on timeline 310 of FIG. 3. Thus, the WLAN communications may include an initial transmission of a trigger frame 335-a from the UE 115 to the AP 110. In response to the trigger frame 335-a, the AP 110 may transmit an ACK 340-a, followed by a transmission of DL data 345-a. The transmission of the DL data 345-a may be followed by a transmission of a BAR 350-a to the UE 115. The UE 115 may respond with a BA 355-a.

The entirety of the WLAN communication are synchronized and scheduled to occur on portions of slots 3-7 of one GSM frame and portions of slot 0 of another GSM frame. Importantly, in this example, the WLAN communications occur during TDM intervals not used for GSM communications.

Thus, UE timeline 315-a illustrates distinct WWAN intervals 360 and WLAN intervals 365 during which the WLAN transceiver chain of the UE 115 may be used for corresponding WWAN communications and WLAN communications. WWAN interval 360-c corresponds to the WWAN communications utilizing the RF switching overhead portions 405-a, 415-a, 425, Rx portion 410-a, and PM portion 420, WLAN interval 365-a corresponds to the WLAN communications that include the trigger frame 335-a, the ACK 340-a, the DL data 345-a, the BAR 350-a, and the BA 355-a, and WWAN interval 360-d corresponds to the WWAN communications utilizing the RF switching overhead portions 405-b, 415-b and Rx portion 410-b.

As with the WLAN timeline 310 of FIG. 3, the WLAN timeline 310-a of FIG. 4 may include multiple WLAN communications triggering the download of multiple DL data packets. To ensure that there is sufficient time within the WLAN interval 365-a for receipt of each DL data 345-a, the UE 115 may measure the time needed for each WLAN communication (for example, from each trigger frame 335-a to BA 355-a) and then use these measurements to determine and enforce a guard interval during which no additional trigger frames 335-a may be attempted.

The timeline 400 illustrates an example timing for GSM and WLAN operations on a shared WLAN transceiver chain when the GSM communications are limited to Rx operations. In this scenario, the GSM frame is approximately 4.62 ms, and of that time, approximately 1.4 ms are not available for WLAN communications. As would be expected, however, the time available for WLAN communications on a shared WLAN transceiver chain decreases when both Tx and Rx GSM operations are used on the shared WLAN transceiver chain.

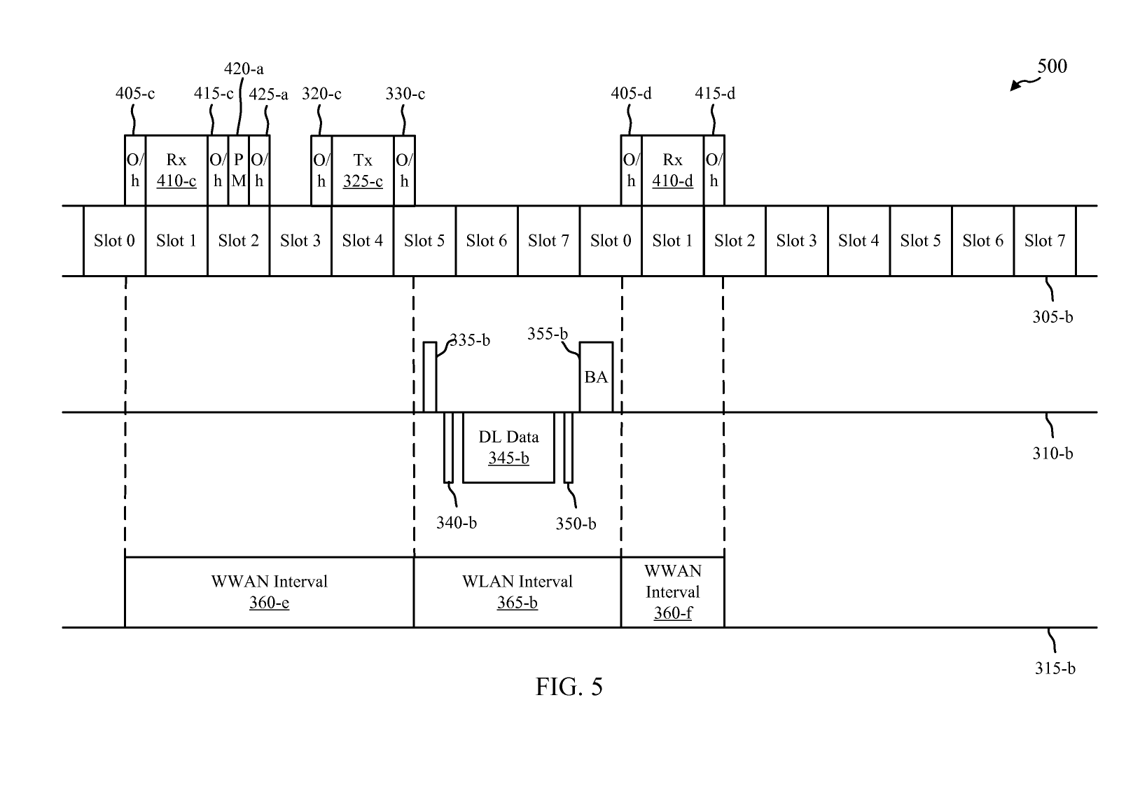

FIG. 5 illustrates a timeline 500 for WLAN scheduling on a shared WLAN transceiver chain of a radio such as radio 210 of UE 115-b of FIG. 2. In particular, timeline 500 illustrates the synchronization of WLAN TDM operations with GSM operations, and the scheduling of TDM intervals for both the WLAN and the GSM communications. In timeline 500, the GSM communications include both GSM Tx and Rx communications. Timeline 500 includes three component timelines: a GSM timeline 305-b, a WLAN timeline 310-b, and a UE timeline 315-b.

The GSM communications are illustrated on the GSM timeline 305-b. As with the other GSM timelines 305 of FIGS. 3 and 4, the GSM timeline 305-b illustrates periodic GSM frames divided into slots (slots 0-7 in each frame). Within each GSM frame are GSM communications. The GSM communications illustrated in GSM timeline 305-b are periodic and involve at least portions of slots 0-5 within each period, leaving only a few slots for WLAN communications. The GSM communications include at least an Rx portion 410 flanked in time by RF switching overhead portions 405, 415, and 425, and PM portion 420 and at least a Tx portion 325 flanked in time by RF switching overhead portions 320, 330. In particular, the scenario illustrated in FIG. 5 anticipates the use of a WLAN transceiver chain for both GSM Rx and GSM Tx operations during a first GSM frame, and then GSM Rx operations during a second GSM frame. Thus, in FIG. 5, RF switching overhead portion 405-c begins during slot 0 and is followed by the Rx portion 410-c which occupies slot 1. After the Rx portion 410-c is complete, RF switching overhead portion 415-c begins, occupying a portion of slot 2. The RF switching overhead portion 415-c is followed by a PM portion 420-a and another RF switching overhead portion 425-a. During slots 3-5, the GSM timeline 305-b illustrates GSM transmission operations. RF switching overhead portion 320-c begins during slot 3 and is followed by the Tx portion 325-c which occupies slot 4. After the Tx portion 325-c is complete, RF switching overhead portion 330-c begins, occupying a portion of slot 5. Some of the GSM communications occur again eight slots later in the form of RF switching overhead portion 405-d, Rx portion 410-d, and RF switching overhead portion 415-d. As no additional WLAN operations occur after the RF switching overhead portion 415-d, no additional PM portions 420 are indicated in the GSM timeline 305-b. However, if additional WLAN communications were to occur, additional PM portions 420 would also be used. Other combinations of Rx portions 410 and Tx portions 325 may also be illustrated.

The WLAN communications are illustrated on the WLAN timeline 310-b. The WLAN communications are synchronized with the GSM communications on the GSM timeline 305-b, and are scheduled so that there is no overlap between the WLAN communications and the GSM communications. The WLAN communications may include both WLAN communications from a UE 115 (such as UE 115-b of FIG. 2) and WLAN communications received at the UE 115 from an AP (such as from AP 110-a of FIG. 2). The WLAN communications illustrated on timeline 310-b are the same as those illustrated on timelines 310 of FIGS. 3 and 4. Thus, the WLAN communications may include an initial transmission of a trigger frame 335-b from the UE 115 to the AP 110. In response to the trigger frame 335-b, the AP 110 may transmit an ACK 340-b, followed by a transmission of DL data 345-b. The transmission of the DL data 345-b may be followed by a transmission of a BAR 350-b to the UE 115. The UE 115 may respond with a BA 355-b.

The entirety of the WLAN communication are synchronized and scheduled to occur on portions of slots 5-7 of one GSM frame and portions of slot 0 of another GSM frame. Importantly, in this example, the WLAN communications occur during TDM intervals not used for GSM communications. However, because of the additional GSM communications occurring on the GSM timeline 305-b, the TDM interval available for WLAN communications is significantly reduced.

UE timeline 315-b illustrates distinct WWAN intervals 360 and WLAN intervals 365 during which the WLAN transceiver chain of the UE 115 may be used for corresponding WWAN communications and WLAN communications. WWAN interval 360-e corresponds to the WWAN communications utilizing the RF switching overhead portions 405-c, 415-c, 425-a, Rx portion 410-c, and PM portion 420-a, as well as the RF switching overhead portions 320-c, 330-c and Tx portion 325-c. The WLAN interval 365-b corresponds to the WLAN communications that include the trigger frame 335-b, the ACK 340-b, the DL data 345-b, the BAR 350-b, and the BA 355-b. The WWAN interval 360-f corresponds to the WWAN communications utilizing the RF switching overhead portions 405-d, 415-d and Rx portion 410-d.

Though having a reduced timing duration, the WLAN timeline 310-b may include multiple WLAN communications triggering the download of multiple DL data packets. To ensure that there is sufficient time within the WLAN interval 365-b for receipt of each DL data 345-b, the UE 115 may measure the time needed for each WLAN communication (for example, from each trigger frame 335-b to BA 355-b) and then use these measurements to determine and enforce a guard interval during which no additional trigger frames 335-b may be attempted.

The timeline 500 illustrates an example timing for GSM and WLAN operations on a shared WLAN transceiver chain when the GSM communications include both Tx and Rx operations. In this scenario, the GSM frame is approximately 4.62 ms, and of that time, approximately 2.7 ms are not available for WLAN communications.

Timelines 300, 400, and 500 of FIGS. 3-5 each include the transmitting of a trigger frame 335 from the UE 115 to the AP 110. As explained above, the trigger frame 335 may be a PS-POLL and acts to individually poll for DL data packets available from the AP 110. However, as an alternative to sending a trigger frame 335, or in addition to, the UE 115 may instead send a different signal to the AP 110 to inform the AP 110 of the timing requirements of the communication protocol sharing the WLAN transceiver chain. For example, the UE 115 could send a signal to the AP 110 informing the AP 110 of timing requirements for GSM or Bluetooth. The AP 110 may then use the received information, in conjunction with the amount of DL data 345 the AP 110 has buffered for download to the UE 115, and then adjust various parameters associated with a transmission to the UE 115. For example, the AP may use the timing information to determine whether to perform or adjust rate adaptation for DL MPDUs. The AP may also use the timing information to select a modulation and coding scheme (MCS) to use in its DL transmissions. Power levels may be adjusted in response to the timing information. The decision of whether to perform MPDU aggregation may also be influenced by the timing information.

Additionally, the AP 110 may also create contention-free periods that are aligned with the start of a WLAN interval 365. Thus, if there is DL data 345 for the UE 115, the DL data 345 will have priority use of DL resources during the contention-free periods. In this scenario, the AP 110 may directly send DL data 345 to the UE 115 without waiting for a trigger frame 335 from the UE 115. The AP 110 may still use a received trigger frame 335, however, for channel estimation, etc. In a scenario where there is no DL data 345 for the UE 115, other UEs 115 or STAs may be able to access the DL resources by winning a contention after the contention-free periods have ended. The number of contention-free periods allowed by an AP 110 may be limited, especially if the number of UEs 115 or STAs is large. In the case of many UEs 115 or STAs, the periodicity of contention-free periods may be less frequent than that allowed by the synchronized and scheduled communications in order to allow each UE 115 or STA a priority access to the DL resources.

In another alternative, instead of informing the AP 110 of the timing requirements of shared communication protocols, the UE 115 may indicate to the AP 110 a duration of time during which the AP 110 may transmit communications to the UE 115. As an example, the indicated duration of time may be included within a network allocation vector (NAV) of the trigger frame 335. The indicated duration of time may indicate the duration of the WLAN interval 365, for example. The AP 110 may then use the received information, in conjunction with the amount of DL data 345 the AP 110 has buffered for download to the UE 115, and then adjust various parameters associated with a transmission to the UE 115. For example, the AP may use the timing information to determine whether to perform or adjust rate adaptation for DL MPDUs. The AP may also use the timing information to select an MCS to use in its DL transmissions. Power levels may be adjusted in response to the timing information. The decision of whether to perform MPDU aggregation may also be influenced by the timing information.

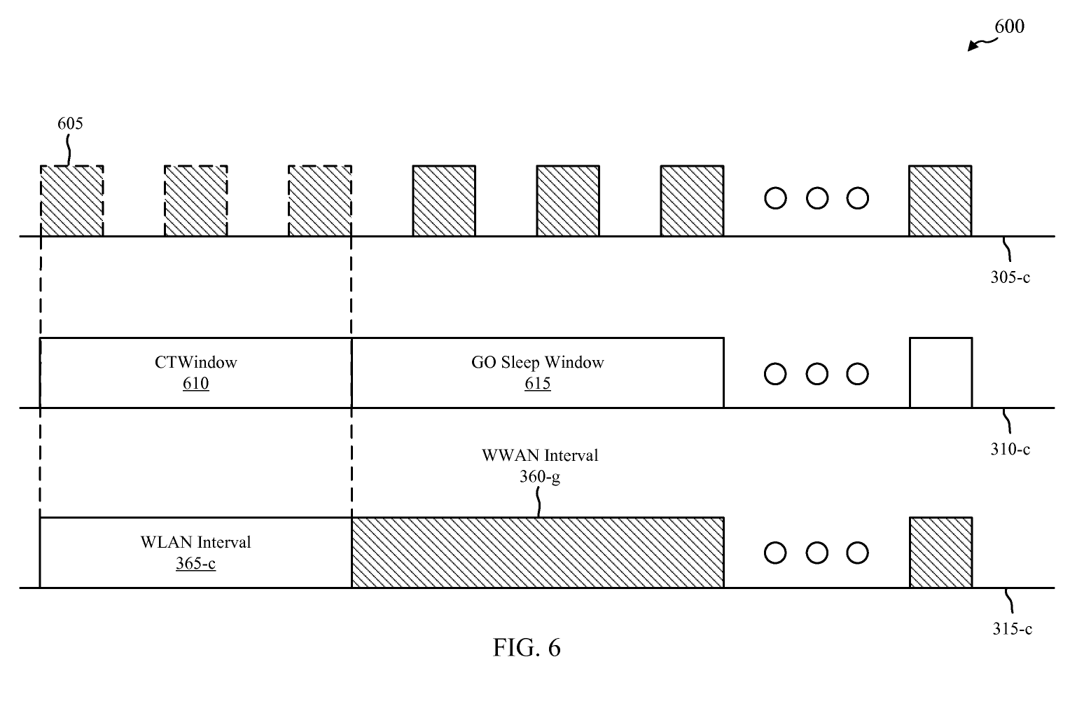

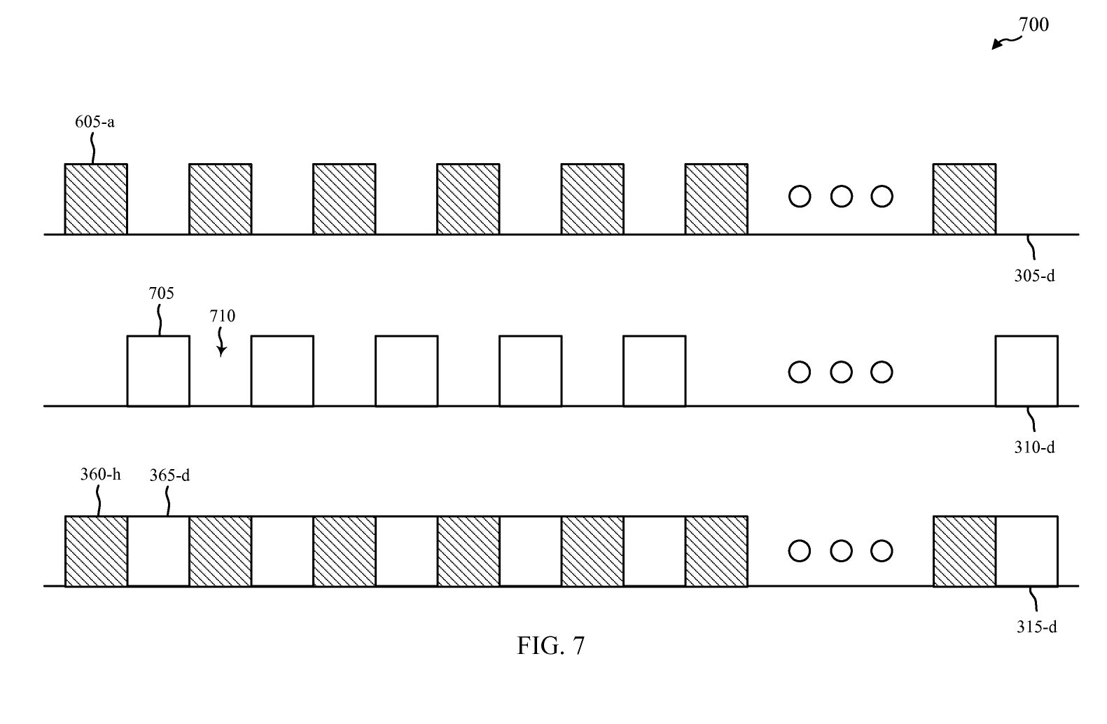

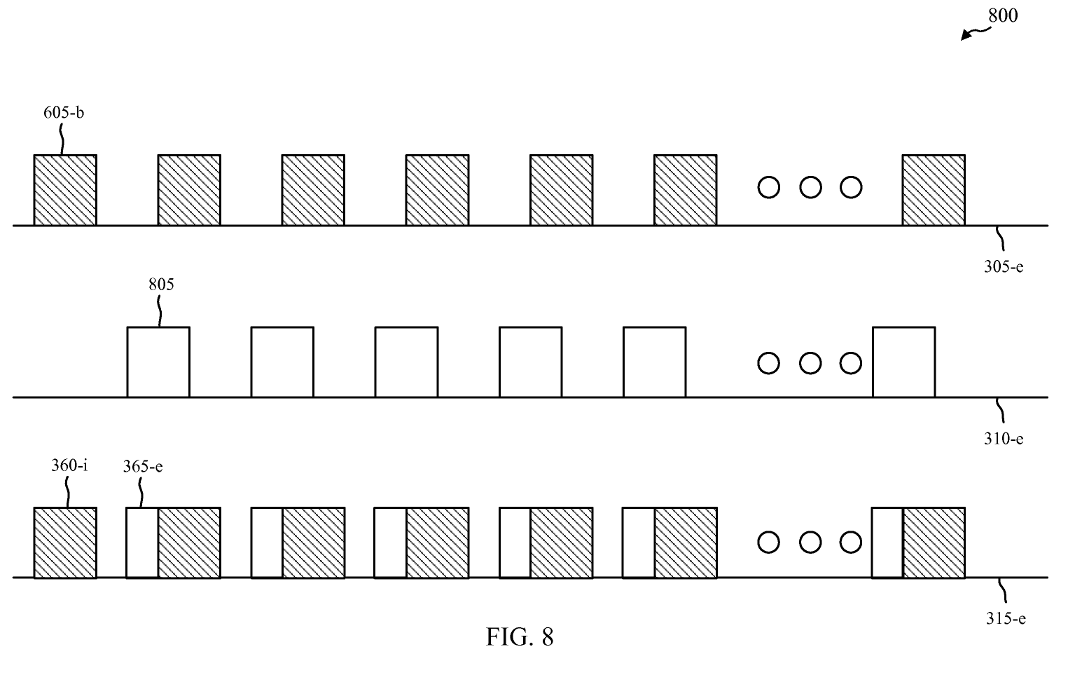

The synchronization and scheduling techniques described above with respect to FIGS. 3-5 may also be applied, with some variation, when the WLAN transceiver chain of the UE 115 is being used for P2P WLAN communications (also known as Wi-Fi Direct). During P2P WLAN communications, a UE 115 may act as either a group owner (GO) or a client. When the UE 115 is a GO, the UE 115 is able to coordinate the transmission schedules for its P2P connections. When the UE 115 is a client, the UE 115 is limited to requesting transmission schedule assistance from a P2P GO. As explained in greater detail below (in connection with FIGS. 6 and 7), when the UE 115 is a P2P GO, opportunistic or Notice of Absence power save mechanisms may be used to accommodate GSM operations. Also as explained below in connection with FIG. 8, when the UE 115 is a P2P client, the UE 115 may use a P2P presence request to accommodate GSM operations.

FIG. 6 illustrates a timeline 600 for P2P WLAN scheduling on a shared WLAN transceiver chain of a radio such as radio 210 of UE 115-b of FIG. 2. In particular, timeline 600 illustrates the synchronization of P2P WLAN operations with GSM operations, and the scheduling of TDM intervals for both the P2P WLAN and the GSM communications. In timeline 600, the UE 115 is acting as a GO for P2P WLAN communications. Timeline 600 includes three component timelines: a GSM timeline 305-c, a WLAN timeline 310-c, and a UE timeline 315-c.

The GSM communications are illustrated on the GSM timeline 305-c. For simplicity, GSM timeline 305-c does not illustrate the slots identified with respect to the GSM timelines 305 of FIGS. 3-5, though the same principles apply in FIG. 6. GSM timeline 305-c is divided into slots and includes various periodic or semi-periodic GSM communications 605 during one or more of the time slots. The GSM communications 605 may include Rx operations, Tx operations, or both Rx and Tx operations.

The WLAN communications are illustrated on the WLAN timeline 310-c. The WLAN communications may include a P2P beacon interval divided into an initial limited presence period such as a CTWindow 610 and a GO sleep window 615. The CTWindow 610 is a period of time in which the UE 115 is available as a GO for P2P WLAN communications with other UEs 115 or STAs. The CTWindow 610 is generally included at the beginning of the P2P beacon interval, and is aligned with a GSM frame. Alternatively, a known offset may be introduced between the P2P beacon interval and the GSM frame. The GO sleep window 615 occurs after the CTWindow 610. In the case that all clients attached to the GO are in a power save mode after the CTWindow 610, the GO may enter into a sleep period during which no P2P communications occur.

One option for synchronizing and scheduling the P2P WLAN communications with the GSM communications 605 includes suspending some of the GSM operations. In particular, as the UE 115, acting as a GO, is meant to be available for P2P WLAN communications with other P2P WLAN clients during the CTWindow 610, the UE 115 may elect to suspend GSM communications 605 during the CTWindow 610. Once the UE 115 enters the GO sleep window 615, the GSM communications 605 may recommence. In an example, the P2P beacon interval may last 102.4 ms, of which 10.24 ms may be reserved for the CTWindow 610. Therefore, 10.24 ms out of every 102.4 ms may not be available for GSM communications 605. This option may result in a moderate increase in GSM packet losses.

The UE timeline 315-c illustrates distinct WWAN intervals 360 and WLAN intervals 365 during which the WLAN transceiver chain of the UE 115 may be used for corresponding WWAN communications and WLAN communications. WLAN interval 365-c corresponds to the P2P WLAN communications that may occur during the CTWindow 610. The WWAN interval 360-g corresponds to the time in which the P2P WLAN operations do not occur—during the GO sleep window 615. This scheduling option may be referred to as an opportunistic power save protocol option.

Another scheduling option is illustrated in FIG. 7. FIG. 7 illustrates a timeline 700 for P2P WLAN scheduling on a shared WLAN transceiver chain of a radio such as radio 210 of UE 115-b of FIG. 2. In particular, timeline 700 illustrates the synchronization of P2P WLAN operations with GSM operations, and the scheduling of TDM intervals for both the P2P WLAN and the GSM communications. In timeline 700, the UE 115 is acting as a GO for P2P WLAN communications. In order to provide shared WLAN transceiver chain scheduling functions, the UE 115 may use a Notice of Absence protocol, as explained below. Timeline 700 includes three component timelines: a GSM timeline 305-d, a WLAN timeline 310-d, and a UE timeline 315-d.

The GSM communications are illustrated on the GSM timeline 305-d. For simplicity, GSM timeline 305-d does not illustrate the slots identified with respect to the GSM timelines 305 of FIGS. 3-5, though the same principles apply in FIG. 7. GSM timeline 305-d is divided into slots and includes various periodic or semi-periodic GSM communications 605-a during one or more of the time slots. The GSM communications 605-a may include Rx operations, Tx operations, or both Rx and Tx operations.

The WLAN communications are illustrated on the WLAN timeline 310-d. Instead of using a P2P beacon interval that includes a CTWindow 610 and a GO sleep window 615, the P2P WLAN communications are instead broken into periodic P2P WLAN availability intervals 705 interspersed with absence periods 710. The UE 115, as a GO, may indicate to other client UEs 115 that the GO will be absent during the absence periods 710. The UE 115, as a GO, may convey the indication in the form of a Notice of Absence. The UE 115, as a GO, may space the absence periods 710 to be approximately the duration of the GSM communications 605-a. Additionally, the absence periods 710 may be synchronized with the GSM communications 605-a. Therefore, during the absence periods 710, the UE 115 may participate in GSM communications 605-a during WWAN intervals 360-h (of UE timeline 315-d). During the P2P WLAN availability intervals 705, the UE 115 may participate in P2P WLAN communications during WLAN intervals 365-d (of UE timeline 315-d). This scheduling option provides more flexibility and potentially less loss than the opportunistic power save protocol option described with reference to FIG. 6.

In FIG. 7, the WLAN communications during the P2P WLAN availability intervals 705 may be adjusted based, at least in part, on timing information of the GSM communications 605-a. The adjustment of the WLAN communications may include determining, by the GO, at least one of a rate, MCS, power level, or degree of aggregation of the WLAN communications. For example, the GO may use the timing information to determine whether to perform or adjust rate adaptation for DL MPDUs. The GO may also use the timing information to select an MCS to use in its DL transmissions. Power levels may be adjusted in response to the timing information. The decision of whether to perform MPDU aggregation may also be influenced by the timing information.

FIG. 8 illustrates another timeline 800 for P2P WLAN scheduling on a shared WLAN transceiver chain of a radio such as radio 210 of UE 115-b of FIG. 2. In timeline 800, the UE 115 is acting as a client during P2P WLAN communications. Therefore, timeline 800 illustrates the synchronization of P2P WLAN operations with GSM operations, and the scheduling of TDM intervals for both the P2P WLAN and the GSM communications to the degree allowed by another P2P GO. Timeline 800 includes three component timelines: a GSM timeline 305-e, a WLAN timeline 310-e, and a UE timeline 315-e.

The GSM communications are illustrated on the GSM timeline 305-e. For simplicity, GSM timeline 305-e does not illustrate the slots identified with respect to the GSM timelines 305 of FIGS. 3-5, though the same principles apply in FIG. 8. GSM timeline 305-e is divided into slots and includes various periodic or semi-periodic GSM communications 605-b during one or more of the time slots. The GSM communications 605-b may include Rx operations, Tx operations, or both Rx and Tx operations.

The WLAN communications are illustrated on the WLAN timeline 310-e. In this option, the UE 115 may communicate with a P2P GO at times allowed by the P2P GO. So, the UE 115 may send a request to the P2P GO that the GO be available for P2P WLAN communications during a period that is in between the GSM communications 605-b. The GO may grant the request, may deny the request, or may modify the request. Therefore, WLAN timeline 310-e may include P2P WLAN communication intervals 805, which may or may not overlap in time with the GSM communications 605-b. Ideally, any overlap is minimized. However, the degree of overlap is largely dependent on the GO's ability to honor the request sent by the UE 115. The request may be that the GO be available for a certain duration, for a certain interval or for a maximum period of time (e.g., a maximum interval).

UE timeline 315-e shows that the WLAN transceiver chain may participate in WWAN communications during a WWAN interval 360-i and may also participate in WLAN communications during a WLAN interval 365-e, though the WLAN interval 365-e may overlap or be cut short by the WWAN interval 360-i.

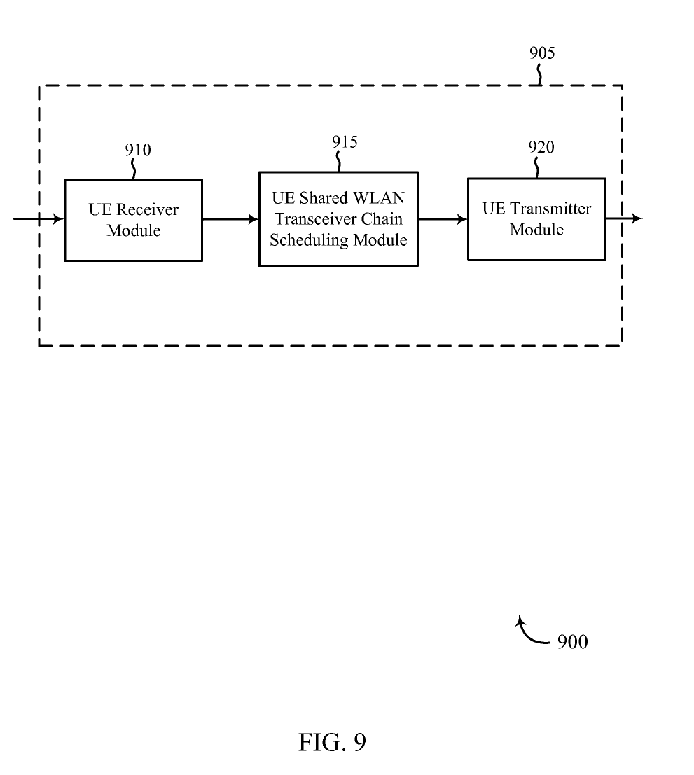

FIG. 9 shows a block diagram 900 of an apparatus 905 for use in wireless communication, in accordance with various aspects of the present disclosure. The apparatus 905 may be an example of one or more aspects of a UE 115 described with reference to FIGS. 1-8. The apparatus 905 may include a UE receiver module 910, a UE shared WLAN transceiver chain scheduling module 915, and/or a UE transmitter module 920. The apparatus 905 may also be or include a processor (not shown). Each of these modules may be in communication with each other.

The components of the apparatus 905 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented, in whole or in part, with instructions embodied in a memory, formatted to be executed by one or more general or application-specific processors.

The UE receiver module 910 may receive information such as packets, user data, and/or control information associated with various information channels (e.g., control channels, data channels, etc.). The UE receiver module 910 may be a WLAN receiver module in a WLAN radio and may be configured to receive both WLAN communications as well as WWAN communications, such as WWAN cell search and measurement information or communications arising from DSDA operation. The received WLAN communications may include communications received from an AP sent in response to a trigger frame or scheduled in accordance with timing information sent from the apparatus 905. The received WLAN communications may also include P2P WLAN communications received from other UEs. Information received may be passed on to the UE shared WLAN transceiver chain scheduling module 915, and to other components of the apparatus 905.

The UE shared WLAN transceiver chain scheduling module 915 may be used to synchronize and schedule communications using different communication protocols on a single WLAN transceiver chain. As an example, the UE shared WLAN transceiver chain scheduling module 915 may synchronize WLAN communications with GSM communications by establishing TDM intervals for each on the WLAN transceiver chain. A WLAN communication may be synchronized with a GSM frame. The GSM communications may occur during a specific TDM interval during the GSM frame and the WLAN communications may occur during the remaining TDM intervals of the GSM frame. In some examples, the UE shared WLAN transceiver chain scheduling module 915 may schedule the GSM and WLAN communications by coordinating the transmittal of a trigger frame to an AP, thus triggering WLAN communications from the AP to occur during a desired TDM interval. In some examples, the UE shared WLAN transceiver chain scheduling module 915 may coordinate the sending of timing information pertaining to GSM communications to the AP to allow the AP to modify its WLAN transmissions in order to accommodate the schedule coordinated by the UE shared WLAN transceiver chain scheduling module 915. In some examples, the UE shared WLAN transceiver chain scheduling module 915 may coordinate the sending of a duration of time during which the AP may transmit DL data packets to the apparatus 905. In additional examples, the UE shared WLAN transceiver chain scheduling module 915 may coordinate GSM communications on a WLAN transceiver chain with P2P WLAN communications.

The UE transmitter module 920 may include a WLAN transmitter (as part of a WLAN radio) and may be used to transmit both WWAN communications (such as GSM communications) and WLAN communications pursuant to the schedule established by the UE shared WLAN transceiver chain scheduling module 915. The UE transmitter module 920 may be used to transmit trigger frames, for example, in order to trigger the transmission of WLAN communications from an AP. The UE transmitter module 920 may also be used to transmit other timing information and time duration information to an AP in order to facilitate the transmission of WLAN communications in accordance with the schedule determined by the UE shared WLAN transceiver chain scheduling module 915. The UE transmitter module 920 may also be used to transmit P2P WLAN communications in accordance with the description above, and may also transmit one or more signals received from other components of the apparatus 905. In some examples, the UE transmitter module 920 may be collocated with the UE receiver module 910 in a transceiver module, such as a WLAN radio.

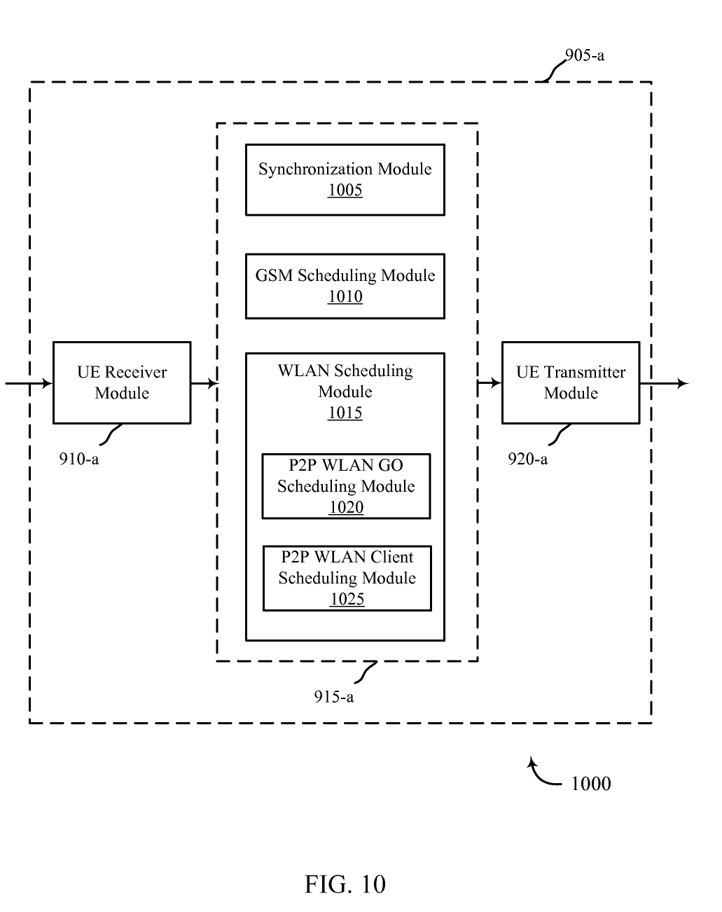

FIG. 10 shows a block diagram 1000 of an apparatus 905-a for use in wireless communication, in accordance with various examples. The apparatus 905-a may be an example of one or more aspects of a UE 115 described with reference to FIGS. 1-8. It may also be an example of an apparatus 905 described with reference to FIG. 9. The apparatus 905-a may include a UE receiver module 910-a, a UE shared WLAN transceiver chain scheduling module 915-a, and/or a UE transmitter module 920-a, which may be examples of the corresponding modules of apparatus 905. The apparatus 905-a may also include a processor (not shown). Each of these components may be in communication with each other. The UE shared WLAN transceiver chain scheduling module 915-a may include a synchronization module 1005, a GSM scheduling module 1010, and a WLAN scheduling module 1015. The WLAN scheduling module 1015 may further include a P2P WLAN GO scheduling module 1020 and/or a P2P WLAN client scheduling module 1025. The UE receiver module 910-a and the UE transmitter module 920-a may perform the functions of the UE receiver module 910 and the UE transmitter module 920, of FIG. 9, respectively.

The synchronization module 1005 may be used to synchronize communications using different communication protocols on a single WLAN transceiver chain. Thus, and for example, the synchronization module 1005 may be used to synchronize WLAN communications with WWAN communications such as GSM communications. GSM communications may include a GSM frame, and the synchronization module 1005 may be used to synchronize WLAN communications with the start of a GSM frame so that the WLAN communications do not overlap (or reduce overlap) with GSM communications in the GSM frame.

The GSM scheduling module 1010 may be used to schedule GSM communications on a WLAN transceiver chain. Once the GSM and WLAN communications are synchronized by the synchronization module 1005, the GSM scheduling module 1010 may be used to ensure that GSM communications occur at a specified time within a GSM frame. For example, the GSM communications may be scheduled to occur at a beginning of a GSM frame. This allows other TDM intervals in which no GSM communications occur to be left open for use in WLAN communications, for example. The GSM scheduling module 1010 may also be used to determine a length of time used by the GSM communications so as to properly allow scheduling of WLAN communications by the WLAN scheduling module 1015. For example, GSM Tx communications may require less time than GSM Rx communications. GSM Rx/Tx communications may require additional time, thus leaving less time for WLAN communications scheduling.

The WLAN scheduling module 1015 may be used to schedule WLAN communications on a WLAN transceiver chain. Once the GSM and WLAN communications are synchronized by the synchronization module 1005, the WLAN scheduling module 1015 may be used to ensure that WLAN communications occur at a specified time so as not to overlap (or so as to reduce overlap) with GSM communications on the WLAN transceiver chain. For example, if the GSM scheduling module 1010 schedules GSM communications to occur at a beginning of a GSM frame, the WLAN scheduling module 1015 may schedule WLAN communications to occur after or between the GSM communications. In some examples, the WLAN scheduling module 1015 may schedule the GSM and WLAN communications by coordinating the transmittal of a trigger frame to an AP, thus triggering WLAN communications from the AP to occur during a desired TDM interval. In some examples, the WLAN scheduling module 1015 may coordinate the sending of timing information pertaining to GSM communications to the AP to allow the AP to modify its WLAN transmissions in order to accommodate the schedule coordinated by the GSM scheduling module 1010 and the WLAN scheduling module 1015. In some examples, the WLAN scheduling module 1015 may coordinate the sending of a duration of time during which an AP may transmit DL data packets to the apparatus 905-a.

The WLAN scheduling module 1015 may additionally include P2P WLAN GO scheduling module 1020 and/or P2P WLAN client scheduling module 1025. These modules may be used to schedule P2P WLAN communications on a shared WLAN transceiver chain.

The P2P WLAN GO scheduling module 1020 may be used to coordinate P2P WLAN communications when the apparatus 905-a is a GO. For example, the P2P WLAN GO scheduling module 1020 may be used to suspend a WWAN communication schedule during a limited presence period such as a CTWindow in a P2P beacon interval. In another example, the P2P WLAN GO scheduling module 1020 may be used to avoid scheduling P2P WLAN communications with clients during GSM communications by determining absence periods during which the GO is not available for P2P WLAN communications and by communicating those absence periods (via, for example, a notice of absence) to the P2P clients.

The P2P WLAN client scheduling module 1025 may be used to determine a P2P WLAN schedule that avoids overlap with GSM communications on the WLAN transceiver chain, and then to request that a GO transmit P2P communications to the apparatus 905-a in accordance with the determined schedule.

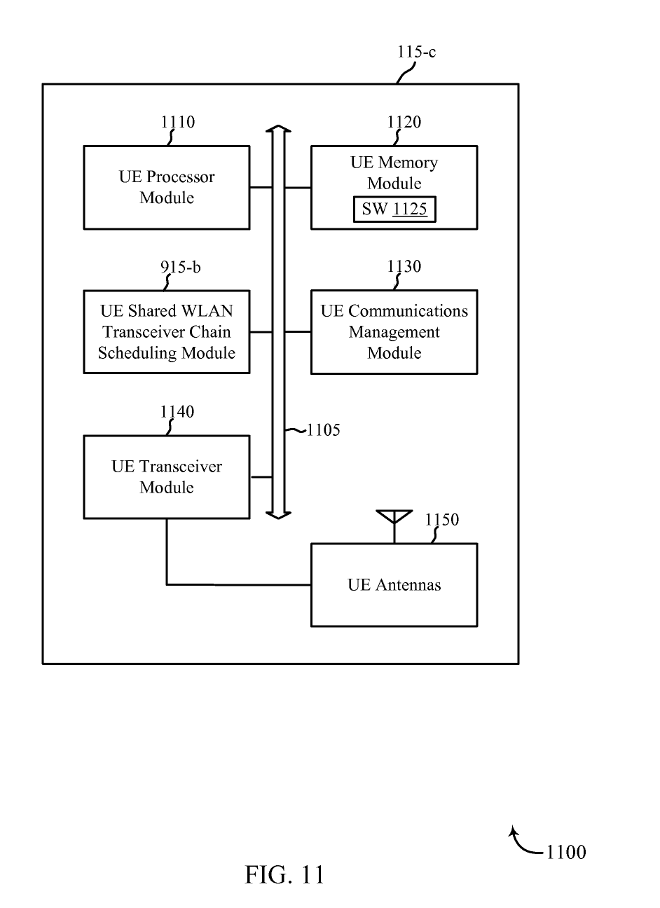

Turning to FIG. 11, a diagram 1100 is shown that illustrates a UE 115-c configured for scheduling communications using different communication protocols on a same WLAN transceiver chain. The UE 115-c may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The UE 115-c may have an internal power supply (not shown), such as a small battery, to facilitate mobile operation. The UE 115-c may be an example of the UEs 115 of FIGS. 1-8.

The UE 115-c may include a UE processor module 1110, a UE memory module 1120, a UE transceiver module 1140, UE antennas 1150, a UE communications management module 1130, and a UE shared WLAN transceiver chain scheduling module 915-b. The UE shared WLAN transceiver chain scheduling module 915-b may be an example of the UE shared WLAN transceiver chain scheduling module 915 of FIG. 9 or 10. Each of these modules may be in communication with each other, directly or indirectly, over at least one bus 1105.

The UE memory module 1120 may include RAM and ROM. The UE memory module 1120 may store computer-readable, computer-executable software (SW) code 1125 containing instructions that are configured to, when executed, cause the UE processor module 1110 to perform various functions described herein for scheduling communications using different communication protocols on a same WLAN transceiver chain. Alternatively, the software code 1125 may not be directly executable by the UE processor module 1110 but be configured to cause the computer (e.g., when compiled and executed) to perform functions described herein.

The UE processor module 1110 may include an intelligent hardware device, e.g., a central processing unit (CPU), a microcontroller, an ASIC, etc. The UE processor module 1110 may process information received through the UE transceiver module 1140 and/or to be sent to the UE transceiver module 1140 for transmission through the UE antennas 1150. The UE processor module 1110 may handle, alone or in connection with the UE shared WLAN transceiver chain scheduling module 915-b, various aspects for synchronizing and scheduling GSM and WLAN communications on a WLAN transceiver chain, for example.

The UE transceiver module 1140 may be configured to communicate bi-directionally with APs 110 and base stations 105 in FIGS. 1-8. The UE transceiver module 1140 may be implemented as at least one transmitter module and at least one separate receiver module. The UE transceiver module 1140 may include at least one WWAN transceiver chain and at least one WLAN transceiver chain. The UE transceiver module 1140 may include a modem configured to modulate the packets and provide the modulated packets to the UE antennas 1150 for transmission, and to demodulate packets received from the UE antennas 1150. The UE 115-c may include multiple UE antennas 1150.

According to the architecture of FIG. 11, the UE 115-c may further include a UE communications management module 1130. The UE communications management module 1130 may manage communications with various APs 110 or base stations 105. The UE communications management module 1130 may be a component of the UE 115-c in communication with some or all of the other components of the UE 115-c over the at least one bus 1105. Alternatively, functionality of the UE communications management module 1130 may be implemented as a component of the UE transceiver module 1140, as a computer program product, and/or as at least one controller element of the UE processor module 1110.

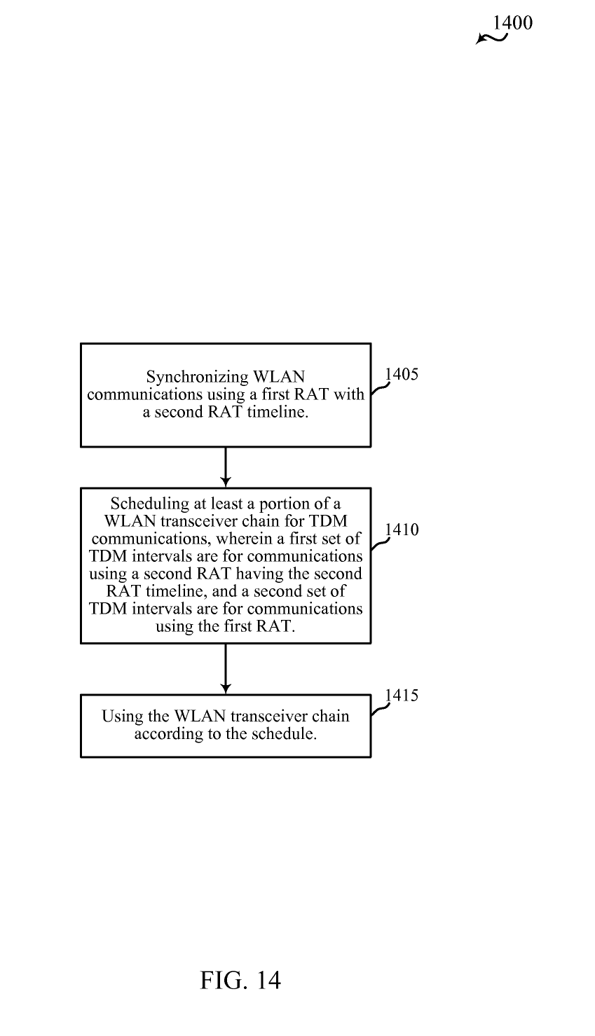

The components of the UE 115-c may be configured to implement aspects discussed above with respect to FIGS. 1-8, and those aspects may not be repeated here for the sake of brevity. Moreover, the components of the UE 115-c may be configured to implement aspects discussed below with respect to FIGS. 14-19, and those aspects may not be repeated here also for the sake of brevity.

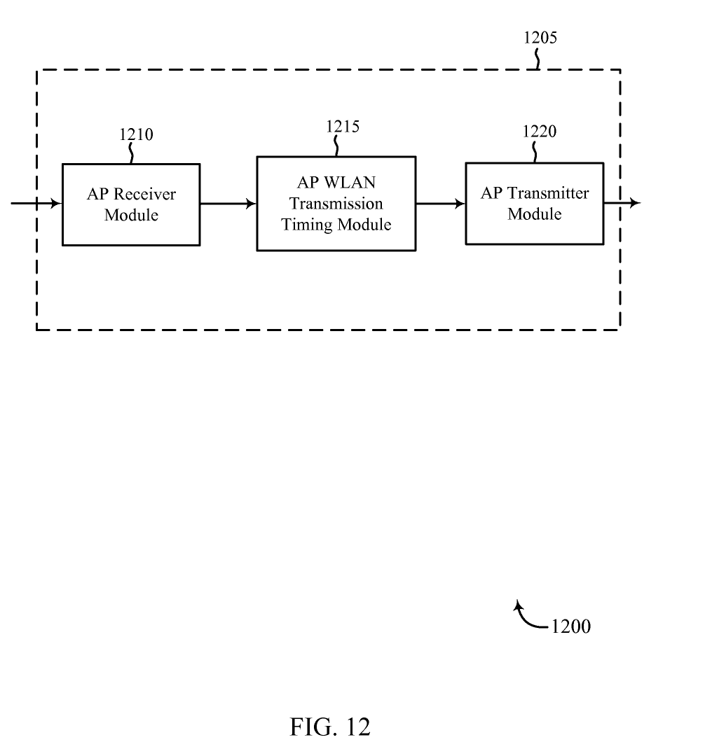

FIG. 12 shows a block diagram 1200 of a device 1205 for use in an AP 110 for wireless communication, in accordance with various aspects of the present disclosure. The device 1205 may be an example of one or more aspects of an APs 110 described with reference to FIGS. 1-8. The device 1205 may include an AP receiver module 1210, an AP WLAN transmission timing module 1215, and/or an AP transmitter module 1220. The device 1205 may also be or include a processor (not shown). Each of these modules may be in communication with each other.

The device 1205, through the AP receiver module 1210, the AP WLAN transmission timing module 1215, and/or the AP transmitter module 1220, may be configured to perform functions described herein. For example, the device 1205 may be configured to receive trigger frames and/or timing information from a UE 115 and use the information to assist in the transmission of WLAN communications to a UE 115 with a shared WLAN transceiver chain.

The components of the device 1205 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

The AP receiver module 1210 may receive information such as packets, user data, and/or control information associated with various information channels (e.g., control channels, data channels, etc.). The AP receiver module 1210 may be configured to receive trigger frames and/or timing information from a UE 115 using a shared WLAN transceiver chain. The trigger frames may indicate that the UE 115 is ready to receive DL transmissions, while the timing information may indicate to the device 1205 that DL transmissions may be transmitted in accordance with a determined schedule set by a requesting UE 115. Information may be passed on to the AP WLAN transmission timing module 1215, and to other components of the device 1205.

The AP WLAN transmission timing module 1215 may be used to adjust the timing of WLAN transmissions to a UE 115 using a shared WLAN transceiver chain. The AP WLAN transmission timing module 1215 may use a trigger frame received from a UE 115 to trigger the transmission of a DL data packet. Additionally, the AP WLAN transmission timing module 1215 may use timing information received from a UE 115 to adjust the transmission of WLAN communications to the UE 115. For example, the AP WLAN transmission timing module 1215 may use the timing information to determine whether to perform or adjust rate adaptation for DL MPDUs. The AP WLAN transmission timing module 1215 may also use the timing information to select an MCS to use in its DL transmissions. Power levels may be adjusted in response to the timing information. The decision of whether to perform MPDU aggregation may also be influenced by the timing information.

The AP transmitter module 1220 may transmit the one or more signals received from other components of the device 1205. The AP transmitter module 1220 may transmit WLAN communications in accordance with adjustments made by the AP WLAN transmission timing module 1215. In some examples, the AP transmitter module 1220 may be collocated with the AP receiver module 1210 in a transceiver module.

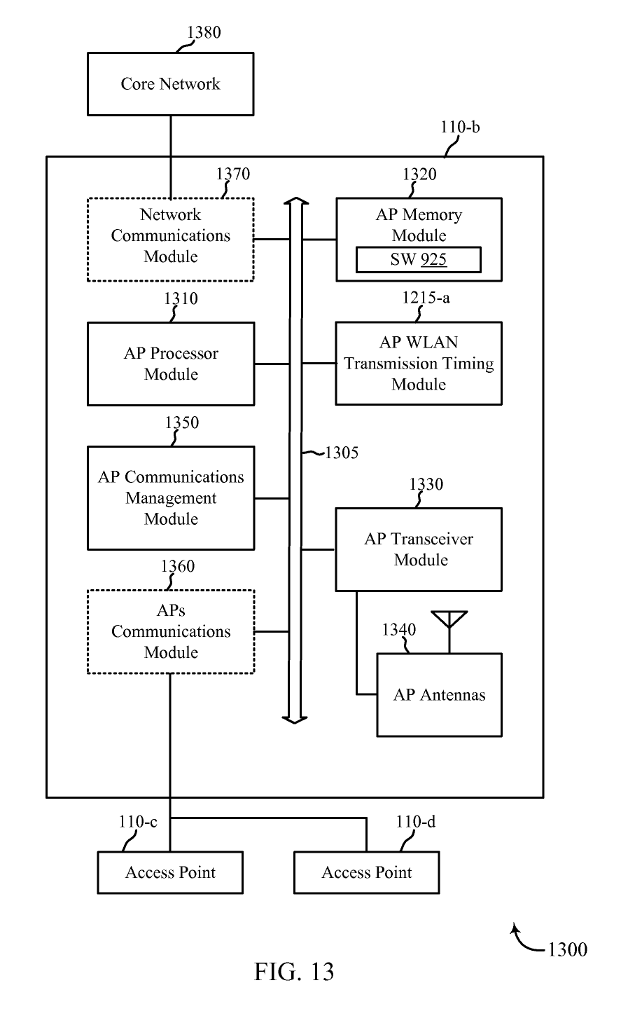

Turning to FIG. 13, a diagram 1300 is shown that illustrates an AP 110-b configured for adjusting DL WLAN transmissions in response to signals received from a UE 115 using a shared WLAN transceiver chain. In some aspects, the AP 110-b may be an example of the APs 110 of FIGS. 1-8. The AP 110-b may include an AP processor module 1310, an AP memory module 1320, an AP transceiver module 1330, AP antennas 1340, and an AP WLAN transmission timing module 1215-a. The AP WLAN transmission timing module 1215-a may be an example of the AP WLAN transmission timing module 1215 of FIG. 12. In some examples, the AP 110-b may also include one or both of an APs communications module 1360 and a network communications module 1370. Each of these modules may be in communication with each other, directly or indirectly, over at least one bus 1305.

The AP memory module 1320 may include random access memory (RAM) and read-only memory (ROM). The AP memory module 1320 may also store computer-readable, computer-executable software (SW) code 1325 containing instructions that are configured to, when executed, cause the AP processor module 1310 to perform various functions described herein for adjusting DL transmissions for UEs 115 using a shared WLAN transceiver chain, for example. Alternatively, the software code 1325 may not be directly executable by the AP processor module 1310 but be configured to cause the computer, e.g., when compiled and executed, to perform functions described herein.

The AP processor module 1310 may include an intelligent hardware device, e.g., a CPU, a microcontroller, an ASIC, etc. The AP processor module 1310 may process information received through the AP transceiver module 1330, the APs communications module 1360, and/or the network communications module 1370. The AP processor module 1310 may also process information to be sent to the AP transceiver module 1330 for transmission through the AP antennas 1340, to the APs communications module 1360, and/or to the network communications module 1370. The AP processor module 1310 may handle, alone or in connection with the AP WLAN transmission timing module 1215-a, various aspects related to adjusting DL transmissions in order to accommodate communications on a shared WLAN transceiver chain of a UE 115.

The AP transceiver module 1330 may include a modem configured to modulate the packets and provide the modulated packets to the AP antennas 1340 for transmission, and to demodulate packets received from the AP antennas 1340. The AP transceiver module 1330 may be implemented as at least one transmitter module and at least one separate receiver module. The AP transceiver module 1330 may be configured to communicate bi-directionally, via the AP antennas 1340, with at least one UE 115 as illustrated in FIG. 1 or 2, for example. The AP 110-b may typically include multiple AP antennas 1340 (e.g., an antenna array). The AP 110-b may communicate with a core network 1380 through the network communications module 1370. The AP 110-b may communicate with other APs, such as the AP 110-c and the AP 110-d, using an APs communications module 1360.

According to the architecture of FIG. 13, the AP 110-b may further include an AP communications management module 1350. The AP communications management module 1350 may manage communications with stations and/or other devices as illustrated in the wireless communications system 100 of FIG. 1. The AP communications management module 1350 may be in communication with some or all of the other components of the AP 110-b via the bus or buses 1305. Alternatively, functionality of the AP communications management module 1350 may be implemented as a component of the AP transceiver module 1330, as a computer program product, and/or as at least one controller element of the AP processor module 1310.

The components of the AP 110-b may be configured to implement aspects discussed above with respect FIGS. 1-8, and those aspects may not be repeated here for the sake of brevity. Moreover, the components of the AP 110-b may be configured to implement aspects discussed below with respect to FIGS. 14-19, and those aspects may not be repeated here also for the sake of brevity.

FIG. 14 is a flow chart illustrating an example of a method 1400 for wireless communication, in accordance with various aspects of the present disclosure. For clarity, the method 1400 is described below with reference to aspects of one or more of the UEs 115 described with reference to FIG. 1-8 or 11, and/or aspects of one or more of the apparatuses 905 described with reference to FIG. 9 or 10. In some examples, a UE may execute one or more sets of codes to control the functional elements of the UE to perform the functions described below. Additionally or alternatively, the UE may perform one or more of the functions described below using-purpose hardware.

At block 1405, the method 1400 may include synchronizing WLAN communications using a first RAT with a secondRAT timeline. The operations at block 1405 may be performed using at least the synchronization module 1005 described with reference to FIG. 10.

At block 1410, the method 1400 may include scheduling at least a portion of a WLAN transceiver chain for TDM communications, wherein a first set of TDM intervals are for communications using a second RAT having the second RAT timeline, and a second set of TDM intervals are for communications using the first RAT. The operations at block 1410 may be performed using at least the GSM scheduling module 1010 and/or the WLAN scheduling module 1015 described with reference to FIG. 10.

At block 1415, the method 1400 may include using the WLAN transceiver chain according to the schedule. The operations at block 1415 may be performed using at least the GSM scheduling module 1010 and/or the WLAN scheduling module 1015 described with reference to FIG. 10.

Thus, the method 1400 may provide for wireless communication. It should be noted that the method 1400 is just one implementation and that the operations of the method 1400 may be rearranged or otherwise modified such that other implementations are possible.

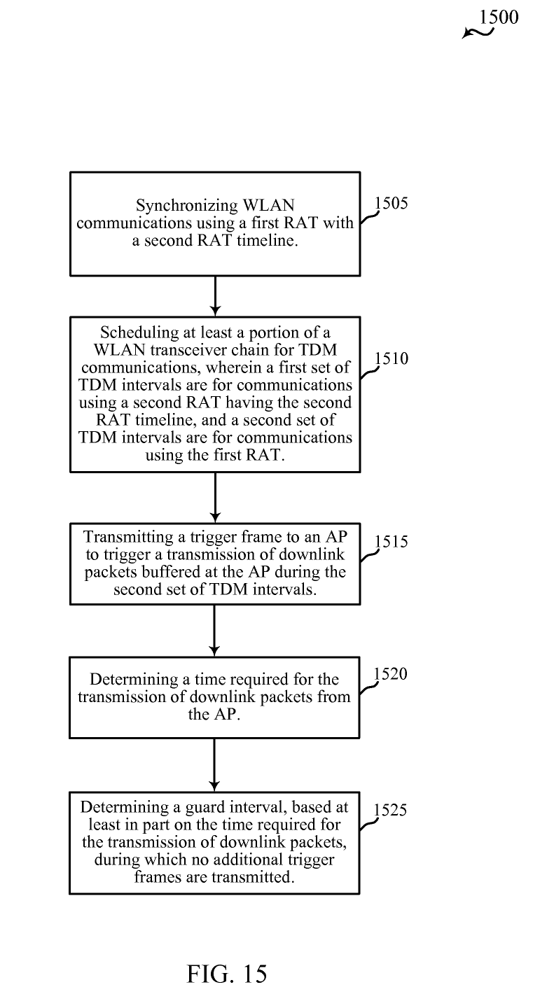

FIG. 15 is a flow chart illustrating an example of a method 1500 for wireless communication, in accordance with various aspects of the present disclosure. For clarity, the method 1500 is described below with reference to aspects of one or more of the UEs 115 described with reference to FIG. 1-8 or 11, and/or aspects of one or more of the apparatuses 905 described with reference to FIG. 9 or 10. In some examples, a UE may execute one or more sets of codes to control the functional elements of the UE to perform the functions described below. Additionally or alternatively, the UE may perform one or more of the functions described below using-purpose hardware.

At block 1505, the method 1500 may include synchronizing WLAN communications using a first RAT with a second RAT timeline. The operations at block 1505 may be performed using at least the synchronization module 1005 described with reference to FIG. 10.

At block 1510, the method 1500 may include scheduling at least a portion of a WLAN transceiver chain for TDM communications, wherein a first set of TDM intervals are for communications using a second RAT having the second RAT timeline, and a second set of TDM intervals are for communications using the first RAT. The operations at block 1510 may be performed using at least the GSM scheduling module 1010 and/or the WLAN scheduling module 1015 described with reference to FIG. 10.

At block 1515, the method 1500 may include transmitting a trigger frame to an AP to trigger a transmission of downlink packets buffered at the AP during the second set of TDM intervals. The operations at block 1515 may be performed using at least the WLAN scheduling module 1015 described with reference to FIG. 10.

At block 1520, the method 1500 may include determining a time required for the transmission of downlink packets from the AP. The operations at block 1520 may be performed using at least the WLAN scheduling module 1015 described with reference to FIG. 10.

At block 1525, the method 1500 may include determining a guard interval, based at least in part on the time required for the transmission of downlink packets, during which no additional trigger frames are transmitted. The operations at block 1525 may be performed using at least the WLAN scheduling module 1015 described with reference to FIG. 10.

Thus, the method 1500 may provide for wireless communication. It should be noted that the method 1500 is just one implementation and that the operations of the method 1500 may be rearranged or otherwise modified such that other implementations are possible.

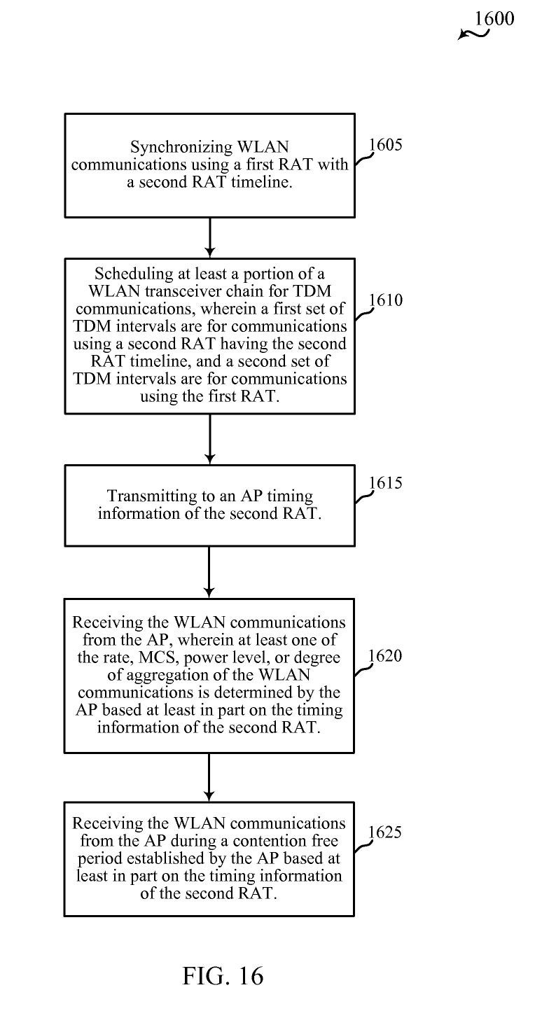

FIG. 16 is a flow chart illustrating an example of a method 1600 for wireless communication, in accordance with various aspects of the present disclosure. For clarity, the method 1600 is described below with reference to aspects of one or more of the UEs 115 described with reference to FIG. 1-8 or 11, and/or aspects of one or more of the apparatuses 905 described with reference to FIG. 9 or 10. In some examples, a UE may execute one or more sets of codes to control the functional elements of the UE to perform the functions described below. Additionally or alternatively, the UE may perform one or more of the functions described below using-purpose hardware.

At block 1605, the method 1600 may include synchronizing WLAN communications using a first RAT with a second RAT timeline. The operations at block 1605 may be performed using at least the synchronization module 1005 described with reference to FIG. 10.

At block 1610, the method 1600 may include scheduling at least a portion of a WLAN transceiver chain for TDM communications, wherein a first set of TDM intervals are for communications using a second RAT having the second RAT timeline, and a second set of TDM intervals are for communications using the first RAT. The operations at block 1610 may be performed using at least the GSM scheduling module 1010 and/or the WLAN scheduling module 1015 described with reference to FIG. 10.

At block 1615, the method 1600 may include transmitting to an AP timing information of the second RAT. The operations at block 1615 may be performed using at least the WLAN scheduling module 1015 described with reference to FIG. 10.

At block 1620, the method 1600 may include receiving the WLAN communications from the AP, wherein at least one of the rate, MCS, power level, or degree of aggregation of the WLAN communications is determined by the AP based at least in part on the timing information of the second RAT. The operations at block 1620 may be performed using at least the WLAN scheduling module 1015 described with reference to FIG. 10.

At block 1625, the method 1600 may include receiving the WLAN communications from the AP during a contention free period established by the AP based at least in part on the timing information of the second RAT. The operations at block 1625 may be performed using at least the WLAN scheduling module 1015 described with reference to FIG. 10.

Thus, the method 1600 may provide for wireless communication. It should be noted that the method 1600 is just one implementation and that the operations of the method 1600 may be rearranged or otherwise modified such that other implementations are possible.

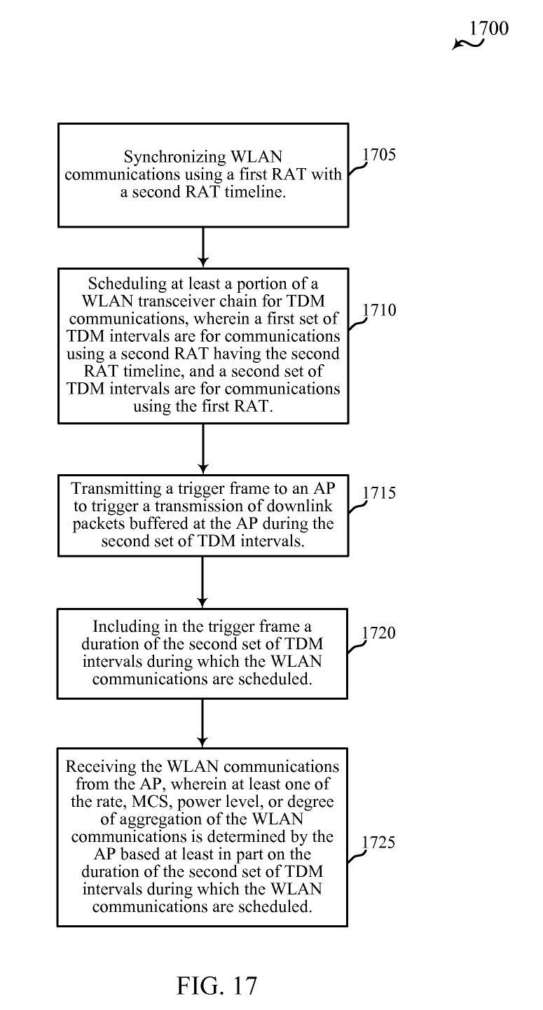

FIG. 17 is a flow chart illustrating an example of a method 1700 for wireless communication, in accordance with various aspects of the present disclosure. For clarity, the method 1700 is described below with reference to aspects of one or more of the UEs 115 described with reference to FIG. 1-8 or 11, and/or aspects of one or more of the apparatuses 905 described with reference to FIG. 9 or 10. In some examples, a UE may execute one or more sets of codes to control the functional elements of the UE to perform the functions described below. Additionally or alternatively, the UE may perform one or more of the functions described below using-purpose hardware.

At block 1705, the method 1700 may include synchronizing WLAN communications using a first RAT with a second RAT timeline. The operations at block 1705 may be performed using at least the synchronization module 1005 described with reference to FIG. 10.

At block 1710, the method 1700 may include scheduling at least a portion of a WLAN transceiver chain for TDM communications, wherein a first set of TDM intervals are for communications using a second RAT having the second RAT timeline, and a second set of TDM intervals are for communications using the first RAT. The operations at block 1710 may be performed using at least the GSM scheduling module 1010 and/or the WLAN scheduling module 1015 described with reference to FIG. 10.

At block 1715, the method 1700 may include transmitting a trigger frame to an AP to trigger a transmission of downlink packets buffered at the AP during the second set of TDM intervals. The operations at block 1715 may be performed using at least the WLAN scheduling module 1015 described with reference to FIG. 10.

At block 1720, the method 1700 may include including in the trigger frame a duration of the second set of TDM intervals during which the WLAN communications are scheduled. The operations at block 1720 may be performed using at least the WLAN scheduling module 1015 described with reference to FIG. 10.

At block 1725, the method 1700 may include receiving the WLAN communications from the AP, wherein at least one of the rate, MCS, power level, or degree of aggregation of the WLAN communications is determined by the AP based at least in part on the duration of the second set of TDM intervals during which the WLAN communications are scheduled. The operations at block 1725 may be performed using at least the WLAN scheduling module 1015 described with reference to FIG. 10.

Thus, the method 1700 may provide for wireless communication. It should be noted that the method 1700 is just one implementation and that the operations of the method 1700 may be rearranged or otherwise modified such that other implementations are possible.

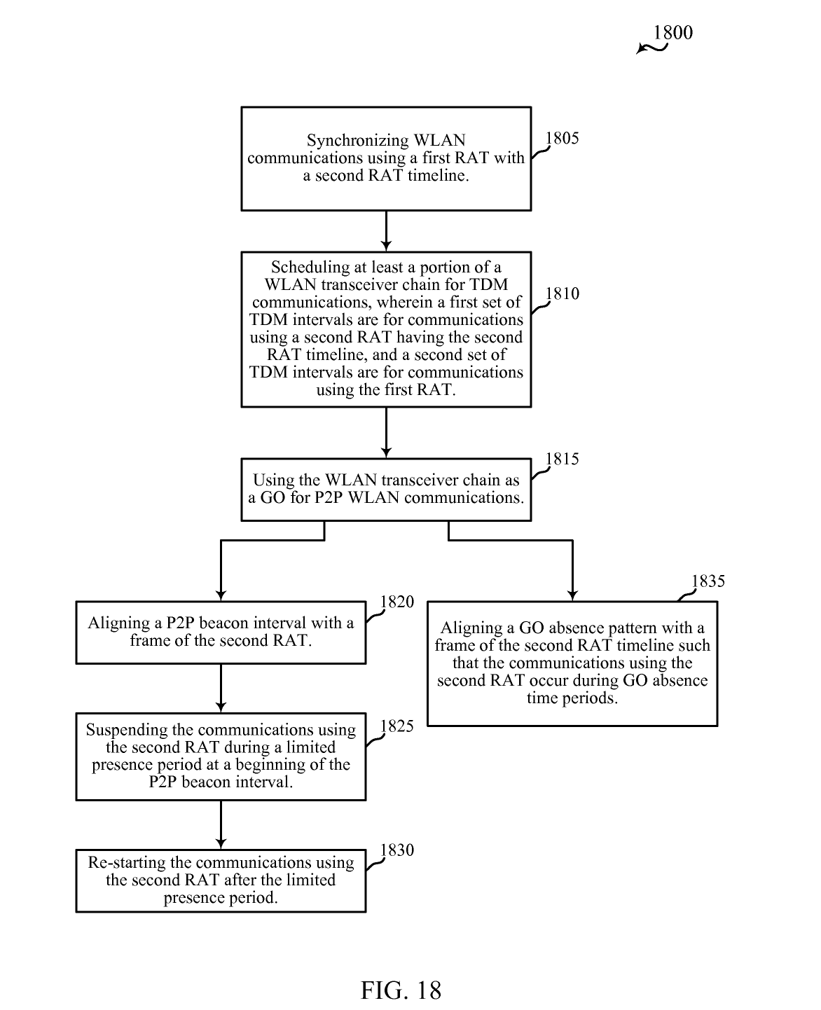

FIG. 18 is a flow chart illustrating an example of a method 1800 for wireless communication, in accordance with various aspects of the present disclosure. For clarity, the method 1800 is described below with reference to aspects of one or more of the UEs 115 described with reference to FIG. 1-8 or 11, and/or aspects of one or more of the apparatuses 905 described with reference to FIG. 9 or 10. In some examples, a UE may execute one or more sets of codes to control the functional elements of the UE to perform the functions described below. Additionally or alternatively, the UE may perform one or more of the functions described below using-purpose hardware.

At block 1805, the method 1800 may include synchronizing WLAN communications using a first RAT with a second RAT timeline. The operations at block 1805 may be performed using at least the synchronization module 1005 described with reference to FIG. 10.

At block 1810, the method 1800 may include scheduling at least a portion of a WLAN transceiver chain for TDM communications, wherein a first set of TDM intervals are for communications using a second RAT having the second RAT timeline, and a second set of TDM intervals are for communications using the first RAT. The operations at block 1810 may be performed using at least the GSM scheduling module 1010 and/or the WLAN scheduling module 1015 described with reference to FIG. 10.

At block 1815, the method 1800 may include using the WLAN transceiver chain as a GO for P2P WLAN communications. The operations at block 1815 may be performed using at least the P2P WLAN GO scheduling module 1020 described with reference to FIG. 10.

Method 1800 includes two distinct options in using the WLAN transceiver chain as a GO for P2P WLAN communications. One option proceeds through blocks 1820, 1825, and 1830.

At block 1820, the method 1800 may include aligning a P2P beacon interval with a frame of the second RAT timeline. The operations at block 1820 may be performed using at least the P2P WLAN GO scheduling module 1020 described with reference to FIG. 10.

At block 1825, the method 1800 may include suspending the communications using the second RAT during a limited presence period at a beginning of the P2P beacon interval. The operations at block 1825 may be performed using at least the P2P WLAN GO scheduling module 1020 described with reference to FIG. 10.

At block 1830, the method 1800 may include re-starting the communications using the second RAT after the limited presence period. The operations at block 1830 may be performed using at least the P2P WLAN GO scheduling module 1020 described with reference to FIG. 10.

The other option for using the WLAN transceiver chain as a GO for P2P WLAN communications, as illustrated in method 1800, proceeds through block 1835.

At block 1835, the method 1800 may include aligning a GO absence pattern with a frame of the second RAT timeline such that the communications using the second RAT occur during GO absence time periods. The operations at block 1835 may be performed using at least the P2P WLAN GO scheduling module 1020 described with reference to FIG. 10.

Thus, the method 1800 may provide for wireless communication. It should be noted that the method 1800 is just one implementation and that the operations of the method 1800 may be rearranged or otherwise modified such that other implementations are possible.

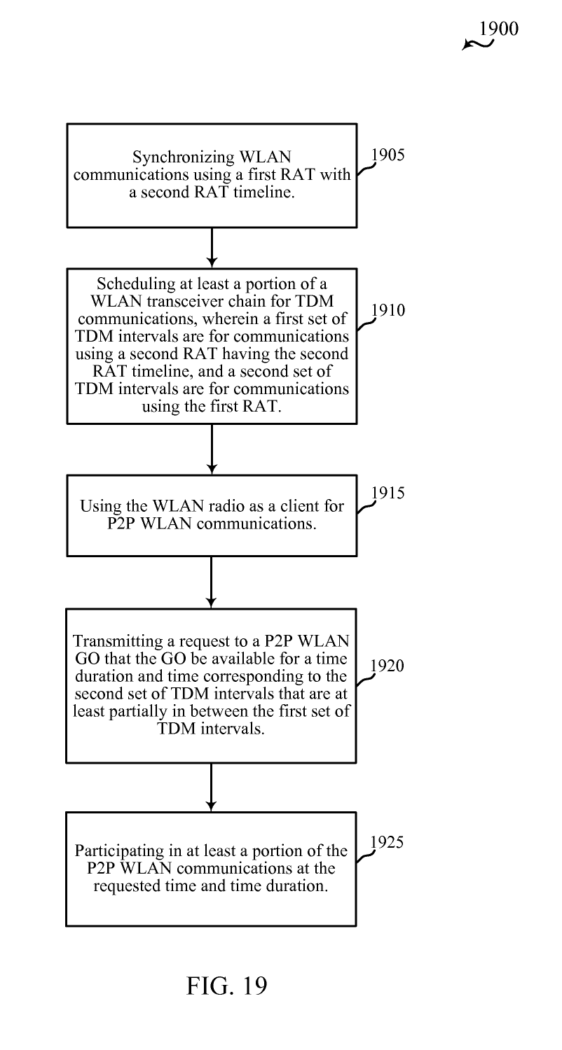

FIG. 19 is a flow chart illustrating an example of a method 1900 for wireless communication, in accordance with various aspects of the present disclosure. For clarity, the method 1900 is described below with reference to aspects of one or more of the UEs 115 described with reference to FIG. 1-8 or 11, and/or aspects of one or more of the apparatuses 905 described with reference to FIG. 9 or 10. In some examples, a UE may execute one or more sets of codes to control the functional elements of the UE to perform the functions described below. Additionally or alternatively, the UE may perform one or more of the functions described below using-purpose hardware.

At block 1905, the method 1900 may include synchronizing WLAN communications using a first RAT with a second RAT timeline. The operations at block 1905 may be performed using at least the synchronization module 1005 described with reference to FIG. 10.

At block 1910, the method 1900 may include scheduling at least a portion of a WLAN transceiver chain for TDM communications, wherein a first set of TDM intervals are for communications using a second RAT having the second RAT timeline, and a second set of TDM intervals are for communications using the first RAT. The operations at block 1910 may be performed using at least the GSM scheduling module 1010 and/or the WLAN scheduling module 1015 described with reference to FIG. 10.

At block 1915, the method 1900 may include using the WLAN transceiver chain as a client for P2P WLAN communications. The operations at block 1915 may be performed using at least the P2P WLAN client scheduling module 1025 described with reference to FIG. 10.

At block 1920, the method 1900 may include transmitting a request to a P2P WLAN GO that the GO be available for a time duration and time corresponding to the second set of TDM intervals that are at least partially in between the first set of TDM intervals. The operations at block 1920 may be performed using at least the P2P WLAN client scheduling module 1025 described with reference to FIG. 10.

At block 1925, the method 1900 may include participating in at least a portion of the P2P WLAN communications at the requested time and time duration. The operations at block 1925 may be performed using at least the P2P WLAN client scheduling module 1025 described with reference to FIG. 10.

Thus, the method 1900 may provide for wireless communication. It should be noted that the method 1900 is just one implementation and that the operations of the method 1900 may be rearranged or otherwise modified such that other implementations are possible.

In some examples, aspects from two or more of the methods 1400, 1500, 1600, 1700, 1800, 1900 may be combined. It should be noted that the methods 1400, 1500, 1600, 1700, 1800, 1900 are just example implementations, and that the operations of the methods 1400, 1500, 1600, 1700, 1800, 1900 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communications, comprising:
synchronizing wireless local area network (WLAN) communications using a first radio access technology (RAT) with a second RAT timeline;
scheduling at least a portion of a WLAN transceiver chain for time-division multiplexed (TDM) communications, wherein a first set of TDM intervals are for communications using a second RAT having the second RAT timeline, and a second set of TDM intervals are for communications using the first RAT; and
using the WLAN transceiver chain according to the schedule.

2. The method of claim 1, wherein scheduling at least the portion of the WLAN transceiver chain comprises:
scheduling the WLAN communications to occur on the second set of TDM intervals so as to avoid overlap with the first set of TDM intervals.

3. The method of claim 1, wherein scheduling at least the portion of the WLAN transceiver chain comprises:
scheduling the WLAN communications to occur during the second set of TDM intervals and in between the first set of TDM intervals which include subsequent Global System for Mobile (GSM) transmit (Tx) operations, subsequent GSM receive (Rx) and power management (PM) operations, or subsequent combined GSM Tx/Rx operations.

4. The method of claim 1, wherein scheduling at least the portion of the WLAN transceiver chain comprises:
scheduling the communications using the second RAT to occur in accordance with a power save mechanism of the first RAT.

5. The method of claim 1, wherein using the WLAN transceiver chain comprises:
transmitting a trigger frame to an access point (AP) to trigger a transmission of one or more downlink packets buffered at the AP during the second set of TDM intervals.

6. The method of claim 1, wherein using the WLAN transceiver chain comprises:
transmitting to an access point (AP) timing information of the second RAT.

7. The method of claim 6, further comprising:
receiving the WLAN communications from the AP, wherein at least one of the rate, modulation and coding scheme (MCS), power level, or degree of aggregation of the WLAN communications is determined by the AP based at least in part on the timing information of the second RAT.

8. The method of claim 6, further comprising:
receiving the WLAN communications from the AP during a contention free period established by the AP based at least in part on the timing information of the second RAT.

9. The method of claim 8, wherein the contention free period is aligned with a start of the second set of TDM intervals.

10. The method of claim 8, wherein the contention free period is one of a plurality of contention free periods established by the AP, each of the plurality of contention free periods corresponding to different devices having corresponding different WLAN transceiver chains.

11. The method of claim 8, wherein the WLAN communications are received from the AP during the contention free period without a transmission of a trigger frame to the AP.

12. The method of claim 6, further comprising:
receiving the WLAN communications from devices other than the AP during a second portion of a contention free period established by the AP based at least in part on the timing information of the second RAT, wherein the receiving of the WLAN communications during the second portion of the contention free period is based in part on a lack of receipt of WLAN communications from the AP during a first portion of the contention free period and is based in part on the devices other than the AP winning a contention during the second portion of the contention free period.

13. The method of claim 1, wherein using the WLAN transceiver chain comprises:
transmitting a trigger frame to an access point (AP) to trigger a transmission of downlink packets buffered at the AP during the second set of TDM intervals;
determining a time required for the transmission of downlink packets from the AP; and
determining a guard interval, based at least in part on the time required for the transmission of downlink packets, during which no additional trigger frames are transmitted.

14. The method of claim 1, wherein using the WLAN transceiver chain comprises:
transmitting a trigger frame to an access point (AP) to trigger a transmission of downlink packets buffered at the AP during the second set of TDM intervals; and
including in the trigger frame a duration of the second set of TDM intervals during which the WLAN communications are scheduled.

15. The method of claim 14, further comprising:
receiving the WLAN communications from the AP, wherein at least one of the rate, modulation and coding scheme (MCS), power level, or degree of aggregation of the WLAN communications is determined by the AP based at least in part on the duration of the second set of TDM intervals during which the WLAN communications are scheduled.

16. The method of claim 1, wherein using the WLAN transceiver chain comprises:
using the WLAN transceiver chain as a group owner (GO) for peer-to-peer (P2P) WLAN communications.

17. The method of claim 16, further comprising:
aligning a P2P beacon interval with a frame of the second RAT timeline;
suspending the communications using the second RAT during a limited presence period at a beginning of the P2P beacon interval; and
re-starting the communications using the second RAT after the limited presence period.

18. The method of claim 16, further comprising:
aligning a GO absence pattern with a frame of the second RAT such that the communications using the second RAT occur during GO absence time periods.

19. The method of claim 16, further comprising:
determining, by the GO, at least one of a rate, modulation and coding scheme (MCS), power level, or degree of aggregation of the WLAN communications based at least in part on timing information of the second RAT.

20. The method of claim 1, wherein using the WLAN transceiver chain comprises:
using the WLAN transceiver chain as a client for peer-to-peer (P2P) WLAN communications.

21. The method of claim 20, further comprising:
transmitting a request to a P2P WLAN group owner (GO) that the GO be available for a time duration and time corresponding to the second set of TDM intervals that are at least partially in between the first set of TDM intervals; and
participating in at least a portion of the P2P WLAN communications at the requested time and time duration.

22. An apparatus for wireless communication, comprising:
means for synchronizing wireless local area network (WLAN) communications using a first radio access technology (RAT) with a second RAT timeline;
means for scheduling at least a portion of a WLAN transceiver chain for time-division multiplexed (TDM) communications, wherein a first set of TDM intervals are for communications using a second RAT having the second RAT timeline, and a second set of TDM intervals are for communications using the first RAT; and
means for using the WLAN transceiver chain according to the schedule.

23. The apparatus of claim 22, wherein the means for scheduling at least the portion of the WLAN transceiver chain comprises:
means for scheduling the WLAN communications to occur on the second set of TDM intervals so as to avoid overlap with the first set of TDM intervals.

24. The apparatus of claim 22, wherein the means for scheduling at least the portion of the WLAN transceiver chain comprises:
means for scheduling the WLAN communications to occur during the second set of TDM intervals and in between the first set of TDM intervals which include subsequent Global System for Mobile (GSM) transmit (Tx) operations, subsequent GSM receive (Rx) and power management (PM) operations, or subsequent combined GSM Tx/Rx operations.

25. The apparatus of claim 22, wherein the means for using the WLAN transceiver chain comprises:
means for transmitting a trigger frame to an access point (AP) to trigger a transmission of one or more downlink packets buffered at the AP during the second set of TDM intervals.

26. The apparatus of claim 22, wherein the means for using the WLAN transceiver chain comprises:
means for transmitting to an access point (AP) timing information of the second RAT.

27. The apparatus of claim 22, wherein the means for using the WLAN transceiver chain comprises:
means for using the WLAN transceiver chain as a group owner (GO) for peer-to-peer (P2P) WLAN communications.

28. The apparatus of claim 22, wherein the means for using the WLAN transceiver chain comprises:
means for using the WLAN transceiver chain as a client for peer-to-peer (P2P) WLAN communications.

29. An apparatus for wireless communication, comprising:
a processor;
memory in electronic communication with the processor; and
instructions stored in the memory, the instructions being executable by the processor to:
synchronize wireless local area network (WLAN) communications using a first radio access technology (RAT) with a second RAT timeline;
schedule at least a portion of a WLAN transceiver chain for time-division multiplexed (TDM) communications, wherein a first set of TDM intervals are for communications using a second RAT having the second RAT timeline, and a second set of TDM intervals are for communications using the first RAT; and
use the WLAN transceiver chain according to the schedule.

30. A non-transitory computer-readable medium storing computer-executable code for wireless communication, the code executable by a processor to:
synchronize wireless local area network (WLAN) communications using a first radio access technology (RAT) with a second RAT timeline;
schedule at least a portion of a WLAN transceiver chain for time-division multiplexed (TDM) communications, wherein a first set of TDM intervals are for communications using a second RAT having the second RAT timeline, and a second set of TDM intervals are for communications using the first RAT; and
use the WLAN transceiver chain according to the schedule.
